(19) United States
(12) Patent Application Publication
(10) Pub. No.: US 2025/0193285 A1
(43) Pub. Date: Jun. 12, 2025

(54) COMMUNICATION SYSTEM, SERVER DEVICE, TERMINAL DEVICE, AND METHOD

(71) Applicant: KABUSHIKI KAISHA TOSHIBA, Tokyo (JP)

(72) Inventor: Yasuyuki TANAKA, Kawasaki (JP)

(73) Assignee: KABUSHIKI KAISHA TOSHIBA, Tokyo (JP)

(21) Appl. No.: 18/796,405

(22) Filed: Aug. 7, 2024

(30) Foreign Application Priority Data
Dec. 12, 2023 (JP) 2023-209212

(51) Int. Cl. H04L 67/143; G16Y 10/75; G16Y 20/40; H04L 67/306

(52) U.S. Cl. CPC H04L 67/143; H04L 67/306; G16Y 10/75; G16Y 20/40

(57) ABSTRACT

According to one embodiment, a communication system includes a server device and a terminal device connected to the server device via a network. The server device includes a first processor configured to provide the terminal device with device function information on a function provided by a communication device when the terminal device discovers the communication device connected to a controller provided in an edge device. The terminal device includes a second processor configured to request the communication device to execute a function provided by the communication device, based on the provided device function information.

### CROSS-REFERENCE TO RELATED APPLICATIONS

This application is based upon and claims the benefit of priority from Japanese Patent Application No. 2023-209212, filed Dec. 12, 2023, the entire contents of which are incorporated herein by reference.

### FIELD

Embodiments described herein relate generally to a communication system, a server device, a terminal device, and a method.

### BACKGROUND

In the technology referred to as Internet Of Things (IoT), edge devices (edge terminals) need to be connected to a network but, if the edge devices do not have communication functions with an IoT server or a cloud, the edge devices can be connected to the network by connecting controllers (host controllers) mounted on the edge devices with communication devices.

By the way, for example, in order to control the above-mentioned edge device, communication device, or the like, the functions provided by the communication device may be executed using a user terminal (terminal device).

However, complicated setup work is required to execute the functions provided by the communication device using a user terminal, and a mechanism to facilitate the functions is desired.

### BRIEF DESCRIPTION OF THE DRAWINGS

FIG. 1 is a diagram showing an example of a system configuration of a communication system according to an embodiment.

FIG. 2 is a diagram showing an example of a functional configuration of a host controller.

FIG. 3 is a diagram showing an example of a functional configuration of a communication device.

FIG. 4 is a diagram showing an example of a functional configuration of a first user terminal.

FIG. 5 is a diagram showing an example of a functional configuration of a server device.

FIG. 6 is a diagram showing an example of a functional configuration of a second user terminal.

FIG. 7 is a diagram showing an example of a hardware configuration of the host controller.

FIG. 8 is a diagram showing an example of a specific aspect of the communication system.

FIG. 9 is a diagram showing a specific example of a lighting fixture.

FIG. 10 is a sequence chart showing an example of a procedure of connection processing.

FIG. 11 is a table showing an example of a data structure of determination information.

FIG. 12 is a table showing an example of a data structure of device information.

FIG. 13 is a sequence chart showing an example of a procedure of device function execution processing.

FIG. 14 is a table showing an example of a data structure of user information.

FIG. 15 is a table showing another example of a data structure of user information.

FIG. 16 is a table showing an example of a data structure of device function information.

FIG. 17 is a diagram illustrating a specific example of an advertisement screen.

FIG. 18 is a diagram illustrating a specific example of an advertisement screen.

FIG. 19 is a diagram illustrating a specific example of an advertisement screen.

FIG. 20 is a diagram illustrating a specific example of an advertisement screen.

FIG. 21 is a diagram illustrating a specific example of an advertisement screen.

FIG. 22 is a diagram illustrating a specific example of an advertisement screen.

FIG. 23 is a diagram illustrating a specific example of an advertisement screen.

FIG. 24 is a diagram illustrating a specific example of an advertisement screen.

FIG. 25 is a diagram illustrating a specific example of an advertisement screen.

FIG. 26 is a diagram showing another example of the functional configuration of the communication device.

FIG. 27 is a diagram showing another example of the functional configuration of the host controller.

FIG. 28 is a sequence chart showing an example of a procedure of a communication system in a case of executing a pairing process between the communication device and the user terminal in advance.

FIG. 29 is a diagram showing an example of a power feeding jig.

FIG. 30 is a view illustrating a configuration of an edge device for which a power supply board separated from the host controller is prepared.

### DETAILED DESCRIPTION

In general, according to one embodiment, a communication system includes a server device and a terminal device connected to the server device via a network. The server device includes a first processor configured to provide the terminal device with device function information on a function provided by a communication device when the terminal device discovers the communication device connected to a controller provided in an edge device. The terminal device includes a second processor configured to request the communication device to execute a function provided by the communication device, based on the provided device function information.

Various embodiments will be described with reference to the accompanying drawings.

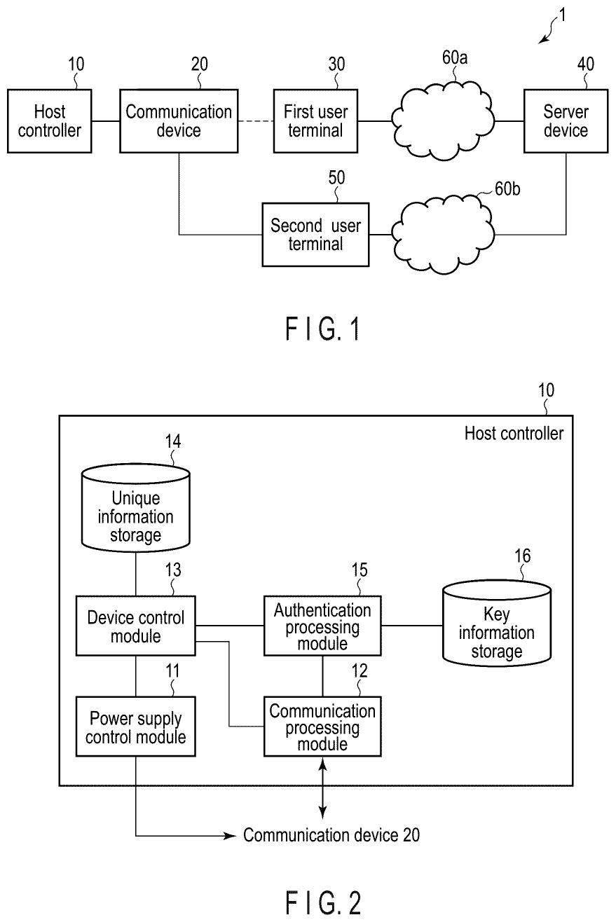

FIG. 1 shows an example of a system configuration of a communication system according to the present embodiment. As shown in FIG. 1, a communication system 1 includes a host controller 10, a communication device 20, a first user terminal 30, a server device 40, and a second user terminal 50.

In the present embodiment, it is assumed that an edge device is used in the technology referred to as IoT, and the host controller 10 is mounted on the edge device and configured to control the operation of the edge device.

In this example, it is assumed that (the edge device including) the host controller 10 of the present embodiment does not include at least a communication function to communicate with a server device (hereinafter referred to as an IoT server) for providing IoT service. In this case, the communication device 20 including a communication function to communicate with the IoT server can be connected to the host controller 10. The host controller 10 can be connected to the IoT server via a predetermined network and can realize the function of the edge device in the IoT, by such a communication device 20.

Incidentally, for example, the host controller 10 and the communication device 20 are connected via a connection interface provided in the edge device such as a USB connector or a pin slot connector but, for example, serial communication such as I2C, URT and SPI or parallel communication may be executed between the host controller 10 and the communication device 20.

The first user terminal 30 is, for example, a terminal device (electronic device) such as a smartphone, a tablet terminal, or a personal computer (PC), used by a user, and includes a function to communicate with the communication device 20. In addition, the first user terminal 30 is communicably connected to the server device 40 via the network 60a.

In the present embodiment, the edge device on which the host controller 10 is mounted can be used in the IoT by connecting the host controller 10 with the communication device 20 as described above. In some cases, for example, only the appropriate communication device 20 needs to be connected to the host controller 10 from the viewpoint of a request from the vendor of the host controller 10 or the viewpoint of security. For this reason, the server device 40 of the present embodiment is configured to determine whether or not the communication device 20 can be connected to the host controller 10 (i.e., the communication device 20 is appropriate for the host controller 10). Information including the result of such a determination executed by the server device 40 (hereinafter referred to as connection availability information) is transmitted (provided) from the server device 40 to the host controller 10.

Incidentally, in the present embodiment, the first user terminal 30 corresponds to a user terminal for setup which sets connection between the host controller 10 and the communication device 20 as described above.

The second user terminal 50 is, for example, a terminal device (electronic device) such as a smartphone, a tablet terminal, and a personal computer (PC) used by a user, and includes a function to communicate with the communication device 20. In addition, the second user terminal 50 is communicatively connected to the server device 40 via a network 60b.

In the present embodiment, it will be considered that when the communication device 20 is connected to the host controller 10 as described above, a function (hereinafter referred to as a device function) provided by the communication device 20 using the second user terminal 50 is executed to control the edge device (host controller 10), the communication device 20, or the like. For this reason, the server device 40 in the present embodiment is configured to determine whether or not the user using the second user terminal 50 is a user who can execute the device function, for example, from the viewpoint of security.

Incidentally, in the present embodiment, it is assumed that the device function is executed by a predetermined application program running on the second user terminal 50 (i.e., application communication is performed to execute the device function), and the second user terminal corresponds to a user terminal for application communication.

Incidentally, wireless communication or wired communication may be executed between the communication device 20 and the first user terminal 30 shown in FIG. 1. For example, communication based on Bluetooth (registered trademark) or Wi-Fi (registered trademark) or the like is assumed as the wireless communication and, for example, communication based on Ethernet (registered trademark) or the like is assumed as the wired communication, but communication based on the other standards may be executed. The communication between the communication device 20 and the first user terminal 30 has been described, but the communication between the communication device 20 and the second user terminal 50 is executed in the same manner.

In addition, the network 60a connecting the first user terminal 30 with the server device 40 may be, for example, a small and closed network such as a local area network (LAN), a wide and closed network such as a wide area network (WAN), or an open network such as the Internet. In addition, the first user terminal 30 executes communication based on, for example, Wi-Fi and cellular communication methods (such as LTE or 5G) to connect to the network 60a, but may be configured to execute communication based on the other standards. The network 60a has been described here, but the network 60b connecting the second user terminal 50 with the server device 40 is configured in the same manner. Incidentally, the networks 60a and 60b may be different networks or the same network.

Furthermore, in the present embodiment, the first user terminal 30 and the second user terminal 50 have been described as separate terminal devices for convenience, but the first user terminal 30 and the second user terminal 50 may be realized as the same terminal device.

FIG. 2 shows an example of a functional configuration of the host controller 10 shown in FIG. 1. As shown in FIG. 2, the host controller 10 includes a power supply control module 11, a communication processing module 12, a device control module 13, a unique information storage 14, an authentication processing module 15, and a key information storage 16.

When the communication device 20 is connected to the host controller 10 via the above-described connection interface in the present embodiment, the power supply control module 11 supplies power to the communication device 20 in accordance with predetermined electrical specifications. The communication device 20 can operate with the power supply executed by the power supply control module 11.

The communication processing module 12 communicates with the communication device 20 which operates based on the power supply of the power supply control module 11 as described above, in a predetermined communication method.

Incidentally, the host controller 10 and the communication device 20 are connected via a connection interface such as a USB connector or a pin slot connector as described above but, for example, the connection interface may be implemented as one connection interface which performs communication and power supply or implemented as a plurality of connection interfaces that execute communication and power supply, respectively.

The device control module 13 controls the power supply control module 11 (power supply function of the host controller 10) and the communication processing module 12 (communication function of the host controller 10). More specifically, the device control module 13 can control, for example, switching enablement and disablement of the power supply function and the communication function.

The unique information storage 14 stores information unique to the host controller 10 (hereinafter referred to as unique information of the host controller 10) in advance. The unique information of the host controller 10 includes, for example, the vendor name, model, firmware version (version of the firmware to control the host controller 10), and the like of the host controller 10. Incidentally, the unique information of the host controller 10 may also include, for example, individual identification information such as a serial number. The unique information of the host controller 10 is read from the unique information storage 14 by the device control module 13 and transmitted to the communication device 20 via the communication processing module 12.

The communication processing module 12 receives connection availability information transmitted from the server device 40 via the communication device 20, which will be described below. An electronic signature (digital signature) generated by the server device 40 may be attached to the connection availability information thus received from the server device 40. The authentication processing module 15 executes a process of verifying such an electronic signature. This process of verifying the digital signature is executed using key information (for example, public key of the server device 40) stored in the key information storage 16.

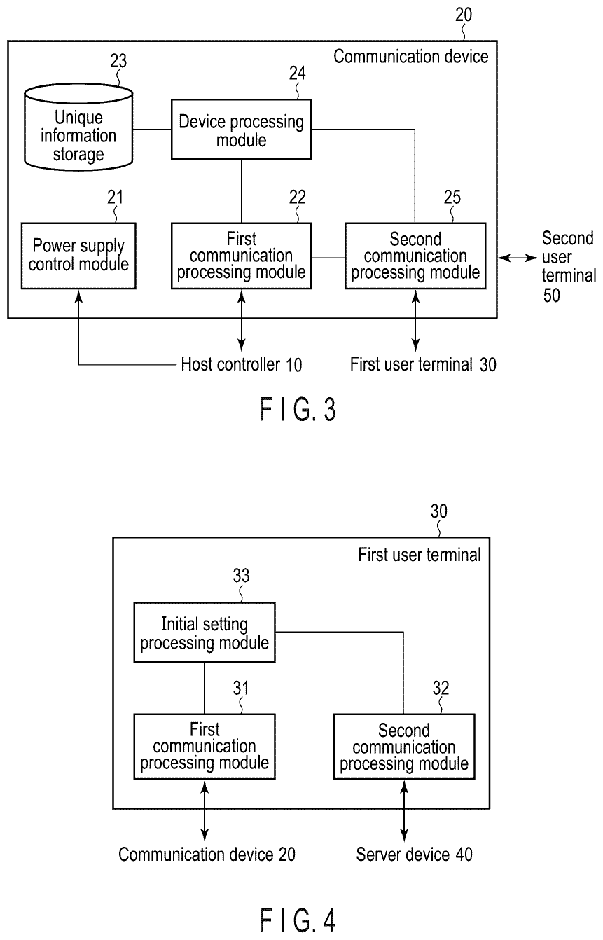

FIG. 3 shows an example of a functional configuration of the communication device 20 shown in FIG. 1. As shown in FIG. 3, the communication device 20 includes a power supply control module 21, a first communication processing module 22, a unique information storage 23, a device processing module 24, and a second communication processing module 25.

The power supply control module 21 drives the communication device 20 by receiving power from the host controller 10 (power supply control module 11).

The first communication processing module 22 communicates with the host controller 10 in a predetermined communication method. Incidentally, the first communication processing module 22 receives the unique information of the host controller 10 transmitted from the host controller 10.

The unique information storage 23 stores information unique to the communication device 20 (hereinafter referred to as the unique information of the communication device 20) in advance. The unique information of the communication device 20 includes, for example, the vendor name, model, firmware version (version of the firmware for controlling the communication device 20), and the like of the communication device 20. Incidentally, the unique information of the communication device 20 may include, for example, individual identification information such as a serial number and a media access control (MAC) address.

Furthermore, the unique information of the communication device 20 includes information on the above-described device function (hereinafter referred to as device function information). The device function information includes, for example, function information and setting information for application communication. The function information for application communication includes, for example, (information on) device functions (functions corresponding to the communication device 20 and firmware for controlling the communication device 20), contents and specifications of application programming interface (API), or the like. The setting information for application communication includes the address, port number, uniform resource locator (URL), security information, and the like of the communication device 20 as information used to execute the device functions and the API. The security information is, for example, a user name, password, and the like, but may also be data referred to as secret. The device function information may include a device name of the communication device 20, and the like.

The device processing module 24 obtains the unique information of the host controller 10 received by the first communication processing module 22 and outputs the obtained unique information to the second communication processing module 25. In addition, the device processing module 24 reads the unique information of the communication device 20 from the unique information storage 23 and outputs the read unique information to the second communication processing module 25. Furthermore, the device processing module 24 can execute, for example, processing corresponding to the edge device in the IoT (i.e., processing unique to the device) as part of the device function.

The second communication processing module 25 communicates with the first user terminal 30 in a predetermined communication method. Incidentally, the second communication processing module 25 transmits the unique information of the host controller 10 and the communication device 20 output from the device processing module 24 to the first user terminal 30 as described above. In addition, the second communication processing module 25 receives the connection availability information transmitted from the server device 40 via the first user terminal 30. The connection availability information thus received by the second communication processing module 25 is transmitted to the host controller 10 by the first communication processing module 22.

In addition, the second communication processing module 25 communicates with the second user terminal 50 in a predetermined communication method. When requested to execute the function which the communication device 20 provides, by the second user terminal 50, the second communication processing section 25 accepts the request. The request accepted by the second communication processing module 25 is processed by the device processing module 24 to provide the device function.

FIG. 4 shows an example of a functional configuration of the first user terminal 30 shown in FIG. 1. As shown in FIG. 4, the first user terminal 30 includes a first communication processing module 31, a second communication processing module 32, and an initial setting processing module 33.

The first communication processing module 31 communicates with the communication device 20 in a predetermined communication method. The second communication processing module 32 communicates with the server device 40 via the network 60a.

Incidentally, the first communication processing module 31 receives the unique information of the host controller 10 and the communication device 20 transmitted from the communication device 20. The initial setting processing module 33 obtains the unique information of the host controller 10 and the communication device 20 thus received by the first communication processing module 31 and transmits the obtained unique information to the server device 40 via the second communication processing module 32.

In addition, the second communication processing module 32 receives the connection availability information transmitted from the server device 40. The initial setting processing module 33 obtains the connection availability information thus received by the second communication processing module 32 and transmits the obtained connection availability information to the communication device 20 via the first communication processing module 31.

The initial setting processing module 33 executes a first setting process for the first communication processing module 31 for communicating with the communication device 20 and a second setting process for the second communication processing module 32 for communicating with the server device 40.

Incidentally, the initial setting processing module 33 executes a process for pairing between the communication device 20 and the first user terminal 30 (hereinafter referred to as a pairing process) as the first setting process. Registering the devices in Bluetooth is generally referred to as pairing but, in the present embodiment, implementing a state in which two devices can communicate with each other by recognizing mutual communication addresses or authenticating each other is referred to as pairing.

In addition, the initial setting processing module 33 executes an authentication process of accepting a user ID and a password by a user using the first user terminal 30, as the second setting process. Alternatively, the initial setting processing module 33 may execute the other preliminary setting process related to security or the like.

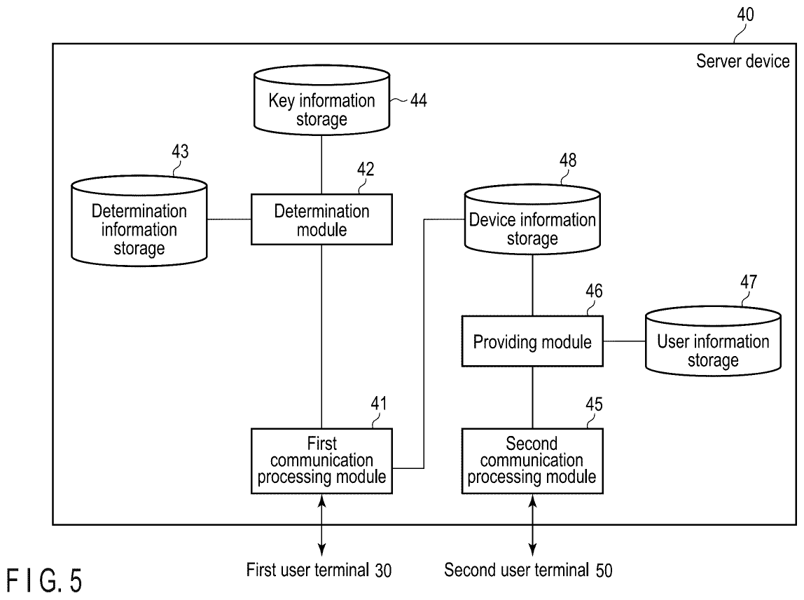

FIG. 5 shows an example of a functional configuration of the server device 40 shown in FIG. 1. As shown in FIG. 5, the server device 40 includes a first communication processing module 41, a determination module 42, a determination information storage 43, a key information storage 44, a second communication processing module 45, a providing module 46, a user information storage 47, and a device information storage 48.

The first communication processing module 41 communicates with the first user terminal 30 via the network 60a. Incidentally, the first communication processing module 41 receives the unique information of the host controller 10 and the communication device 20 transmitted from the first user terminal 30.

The determination module 42 obtains the unique information of the host controller 10 and the communication device 20 received by the first communication processing module 41, and determines whether or not the communication device 20 can be connected to the host controller 10, based on the obtained unique information. Incidentally, the determination process of the determination module 42 is executed using the determination information stored in the determination information storage 43. Details of the determination information stored in the determination information storage 43 will be described below.

The determination module 42 generates an electronic signature (digital signature) that is attached to the connection availability information including the determination result of the determination module 42. Incidentally, the electronic signature is generated using the key information (for example, the private key of the server device 40) stored in the key information storage 44.

The connection availability information to which the electronic signature generated as described above is attached is transmitted to the first user terminal 30 by the first communication processing module 41.

The second communication processing module 45 communicates with the second user terminal 50 via the network 60b. The second communication processing module 45 accepts an inquiry for the device function from the second user terminal 50, which will be described below.

When an inquiry is received by the second communication processing module 45 (i.e., the inquiry is made by the second user terminal 50), the providing module 46 determines whether or not the user using the second user terminal 50 is a user capable of executing the device function. Incidentally, the determination process of the providing module 46 is executed using the user information stored in the user information storage 47. Details of the user information stored in the user information storage 47 will be described below.

The unique information of the communication device 20, which is received by the above-described first communication processing module 41, includes device function information. The device information including this device function information is stored in the device information storage 48.

Based on the result of the determination executed by the providing module 46, the providing module 46 provides (transmits) the device function information included in the device information stored in the device information storage 48 to the second user terminal 50 via the second communication processing module 45 as a response to the inquiry received by the second communication processing module 45.

Incidentally, it has been described that the server device 40 includes the first communication processing module 41 and the second communication processing module 45 in FIG. 5, but the first communication processing module 41 and second communication processing module 45 may be configured as a single communication processing module.

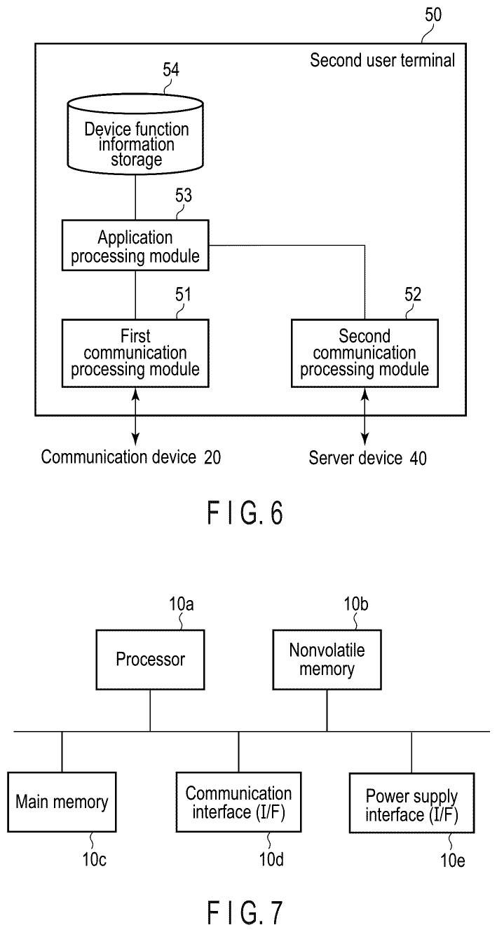

FIG. 6 shows an example of a functional configuration of the second user terminal 50 shown in FIG. 1. As shown in FIG. 6, the second user terminal 50 includes a first communication processing module 51, a second communication processing module 52, an application processing module 53, and a device function information storage 54.

The first communication processing module 51 communicates with the communication device 20 in a predetermined communication method. The second communication processing module 52 communicates with the server device 40 via the network 60b.

It is assumed that, for example, communication based on Bluetooth is executed between the communication device 20 and the second user terminal 50. For example, when the second user terminal 50 is located within a communication range of the communication device 20, the first communication processing module 51 can receive, for example, the data periodically transmitted from the communication device 20.

The application processing module 53 can discover the communication device 20 (i.e., recognize the existence of the communication device 20) when data is received by the first communication processor 51 in this manner. When the communication device 20 is discovered, the application processing module 53 makes an inquiry to the device function via the second communication processing module 52.

The second communication processing module 52 receives the device function information provided by the server device 40 in response to the inquiry. The application processing module 53 stores the device function information received by the second communication processing module 52 in the device function information storage 54.

Based on the device function information stored in the device function information storage 54, the application processing module 53 requests the communication device 20 to execute the device function via the first communication processing module 51.

Detailed description will be omitted, but a setting process for the first communication processing module 51 to communicate with the communication device 20 (i.e., a process corresponding to the first setting process in the first user terminal 30) and a setting process for the second communication processing module 52 to communicate with the server device 40 (i.e., a process corresponding to the second setting process in the first user terminal 30) may be executed in the second user terminal 50.

FIG. 7 shows an example of a hardware configuration of the above-described host controller 10. As shown in FIG. 7, the host controller 10 includes a processor 10a, a nonvolatile memory 10b, a main memory 10c, a communication interface (I/F) 10d, a power supply interface (I/F) 10e, and the like.

The processor 10a is configured to control the operation of each component in the host controller 10 and may be, for example, a CPU or the like. Alternatively, the processor 10a may be a single processor or may be composed of a plurality of processors. The processor 10a executes various programs that are loaded from the nonvolatile memory 10b into the main memory 10c. The communication interface 10d is, for example, an interface which realizes communication with the communication device 20. The power supply interface 10e is, for example, an interface which realizes power supply to the communication device 20.

In the present embodiment, some or all of the power supply control module 11, the communication processing module 12, the device control module 13, and the authentication processing module 15 shown in FIG. 2 may be realized by urging the processor 10a shown in FIG. 7 to execute a predetermined program (i.e., software), by hardware such as an integrated circuit (IC), or by a configuration obtained by combining software and hardware.

In addition, in the present embodiment, the unique information storage 14 and the key information storage 16 shown in FIG. 2 are realized by the nonvolatile memory 10b shown in FIG. 7.

The hardware configuration of the host controller 10 has been described, but it is assumed that the communication device 20, the first user terminal 30, the server device 40 and the second user terminal 50 also have substantially the same hardware configuration.

In this case, some or all of the power supply control module 21, the first communication processing module 22, the device processing module 24, and the second communication processing module 25 shown in FIG. 3 may be realized by urging the processor (CPU) provided in the communication device 20 to execute a predetermined program (i.e., by software), by hardware, or by a configuration obtained by combining software and hardware. The unique information storage 23 shown in FIG. 3 is realized by a nonvolatile memory provided in the communication device 20.

In addition, some or all of the first communication processing module 31, the second communication processing module 32, and the initial setting processing module 33 shown in FIG. 4 may be realized by urging the processor (CPU) provided in the first user terminal 30 to execute a predetermined program (application program) (i.e., by software), by hardware, or by a configuration obtained by combining software and hardware.

Furthermore, some or all of the first communication processing module 41, the determination module 42, the second communication processing module 45, and the providing module 46 shown in FIG. 5 may be realized by urging the processor (CPU) provided in the server device 40 to execute a predetermined program (application program) (i.e., by software), by hardware, or by a configuration obtained by combining software and hardware. The determination information storage 43, the key information storage 44, the user information storage 47, and the device information storage 48 shown in FIG. 5 are realized by nonvolatile memory provided in the server device 40.

In addition, some or all of the first communication processing module 51, the second communication processing module 52, and the application processing module 53 shown in FIG. 6 may be realized by urging the processor (CPU) provided in the first user terminal 30 to execute a predetermined program (application program) (i.e., by software), by hardware, or by a configuration obtained by combining software and hardware.

In the present embodiment, the first user terminal 30 and the second user terminal 50 may further include, for example, input devices, display devices, and the like.

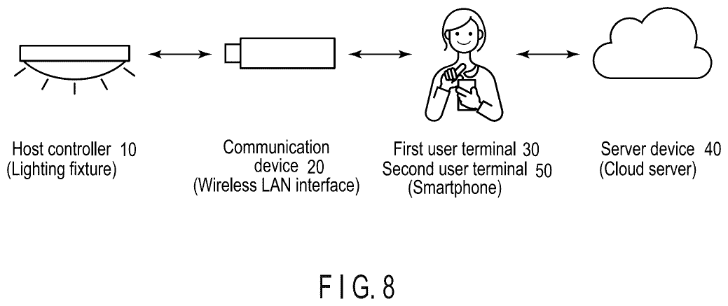

FIG. 8 shows an example of a specific aspect of the above-described communication system 1 shown in FIG. 1.

In the example shown in FIG. 7, it is assumed that the edge device incorporating the host controller 10 is a lighting fixture, the communication device 20 is a wireless LAN interface, the first user terminal 30 and the second user terminal 50 are smartphones, and the server device 40 is a cloud server providing cloud computing services. Incidentally, the first user terminal 30 and the second user terminal 50 are shown as one smartphone for convenience in FIG. 8, but the first user terminal 30 and the second user terminal 50 may be separate smartphones.

According to such a communication system 1, connection between the lighting fixture and the wireless LAN interface can be permitted or rejected by, for example, determining permission of the connection between the lighting fixture and the wireless LAN interface at the cloud server.

Incidentally, when the connection between the lighting fixture and the wireless LAN interface is permitted, IoT services such as collecting sensor data related to the lighting fixture measured by various sensors or remotely driving the lighting fixture can be realized.

Furthermore, a user using the second user terminal 50, for example, can execute the device functions by operating the second user terminal 50.

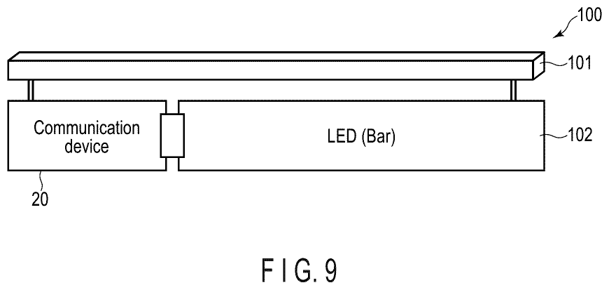

In addition, FIG. 9 shows a specific example of the above-described lighting fixture (edge device). In the example shown in FIG. 9, a lighting fixture 100 includes a lighting fixture body 101 and an LED (bar) 102.

Although not shown in FIG. 9, the lighting fixture body 101 incorporates the host controller 10, and the host controller 10 is connected to the communication device 20 (wireless LAN interface). The lighting fixture body 101 (host controller 10) is connected to, for example, a commercial power source, and can supply power to the communication device 20 connected to the host controller 10.

The LED 102 is supplied with power from the lighting fixture body 101. In addition, for example, the communication device 20 incorporates an actuator which drives the LED 102, and the actuator is connected to the LED 102 via a dimming interface (I/F). According to this, for example, the LED 102 can be dimmed by controlling the actuator, based on a control signal received in the communication device 20.

An operation of the communication system 1 according to the present embodiment will be described below. In the present embodiment, a process of connecting the communication device 20 to the host controller 10 (hereinafter referred to as “connection process”) and a process of executing the device function using the second user terminal 50 (hereinafter referred to as “device function execution process”) will be described.

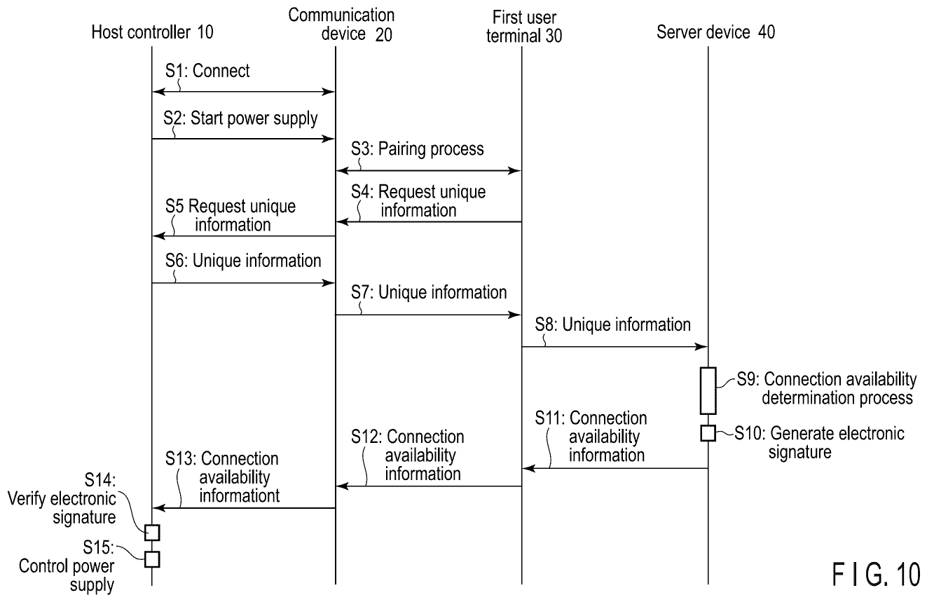

An example of a procedure of the connection process will be described with reference to a sequence chart of FIG. 10.

First, it is assumed that (the edge device incorporating) the host controller 10 and the communication device 20 are connected via a connection interface (step S1).

When the process of step S1 is executed, the connection of the communication device 20 is recognized by the host controller 10, and the device control module 13 included in the host controller 10 instructs the power supply control module 11 to supply power to the communication device 20. As a result, the power supply control module 11 starts supplying power to the communication device 20 (step S2).

When the process of step S2 is executed, the power supply from the host controller 10 to the communication device 20 is executed, and the power supply control module 21 included in the communication device 20 drives the communication device 20 by receiving the power supply. As a result, the communication device 20 starts the operation.

In this case, the device control module 13 included in the host controller 10 instructs the communication processing module 12 to execute data communication with the communication device 20. According to this, communication between the host controller 10 and the communication device 20 can be executed.

When the communication device 20 starts the operation as described above, the initial setting processing module 33 included in the first user terminal 30 executes the pairing process as the first setting process for the first communication processing module 31 to communicate with the communication device 20 (step S3). Incidentally, the information on pairing (for example, information on a partner with whom pairing has been completed) is held in the communication device 20 and the first user terminal 30, and the pairing process is executed when it is recognized that pairing the communication device 20 and the first user terminal 30 has not been completed based on the information on pairing.

More specifically, for example, when the communication device 20 in the initialized state starts the operation (i.e., power is supplied to the communication device 20), the communication device 20 becomes a state of waiting for pairing. The initial setting processing module 33 included in the first user terminal 30 executes the pairing process according to the method of communication with the communication device 20. For example, when the communication method is Bluetooth, the communication device 20 is displayed as a device that can be paired on the graphical user interface (GUI) prepared in the first user terminal 30, and the pairing process is executed by the user selecting the displayed communication device 20 by a predetermined operation. In addition, when the communication method is Wi-Fi, the communication device 20 operates as a Wi-Fi access point, and a predetermined SSID and a predetermined password are input to the first user terminal 30 and the pairing process is thereby executed (i.e., the first user terminal 30 becomes connectible to the Wi-Fi network of the communication device 20).

When the above-described pairing is completed (successful), the information of the first user terminal 30 whose pairing with the communication device 20 is completed is held in the communication device 20, and the information of the communication device 20 whose pairing with the first user terminal 30 is completed is held in the first user terminal 30. As a result, the first user terminal 30 can communicate with the communication device 20.

Incidentally, the communication device 20 and the first user terminal 30 may be connected by a wired manner but, in such a case, an explicit pairing process may be omitted.

By the way, for example, when the first user terminal 30 executes communication with the communication device 20 based on Bluetooth, the first user terminal 30 needs to be located within a range of communication with the communication device 20. In other words, when the first user terminal 30 is not located within the range of communication with the communication device 20, pairing cannot be completed (pairing fails).

If pairing cannot be completed, the connection availability information is not received via the communication device 20, and the power supply from the host controller 10 to the communication device 20 therefore does not need to be continued. Therefore, for example, if the connection availability information is not received from the server device 40, the power supply from the host controller 10 to the communication device 20 may be stopped. In this case, for example, if the connection availability information is not received before a certain period of time elapses after the power supply to the communication device 20 is started, the power supply control module 11 included in the host controller 10 can stop the power supply. More specifically, for example, expiration date information indicative of an expiration date calculated by adding the above-described certain period to the date and time when the host controller 10 and the communication device 20 are connected may be set, and the power supply may be stopped when the expiration date expires.

In contrast, a communication error may occur due to the communication environment between the communication device 20 and the first user terminal 30, and the pairing may not be able to be completed. However, if the communication error occurs temporarily, the pairing may be completed by executing the pairing process again when the communication error is resolved. In such a case, if the power supply to the communication device 20 is stopped, the communication device 20 cannot operate and the pairing process cannot be executed. For this reason, even if the power supply to the communication device 20 is stopped for the reason that the connection availability information is not received before a certain period of time elapses as described above, the power supply control module 11 included in the host controller 10 may resume the power supply when a predetermined period of time has further elapsed after the power supply is stopped. Incidentally, the resumption of the power supply to the communication device 20 may be realized by manual operations on the host controller 10. In addition, for example, the power supply to the communication device 20 may be able to be executed temporarily by an operation of pressing a button provided on the host controller 10 for a certain period of time.

When the process of step S3 is executed, the initial setting processing module 33 included in the first user terminal 30 requests the unique information from the communication device 20 via the first communication processing module 31 (step S4). Incidentally, for example, the process of step S4 may be executed automatically after the process of step S3 is executed or may be executed in response to the user operation on the first user terminal 30.

The device processing module 24 included in the communication device 20 accepts a request from the first user terminal 30 via the second communication processing module 25 and requests the unique information from the host controller 10 via the first communication processing module 22 (step S5).

The device control module 13 included in the host controller 10 accepts the request from the communication device 20 via the communication processing module 12. Based on the accepted request, the device control module 13 reads the unique information of the host controller 10 from the unique information storage 14.

The (response message including) unique information of the host controller 10, which is read from the unique information storage 14, is transmitted to the communication device 20 via the communication processing module 12 (step S6). The unique information of the host controller 10 transmitted in step S6 is received by the first communication processing module 22 included in the communication device 20.

In addition, the device processing module 24 included in the communication device 20 reads the unique information of the communication device 20 from the unique information storage 23, based on the request from the first user terminal 30, which is accepted via the second communication processing module 25 as described above.

The (response message including) unique information of the host controller 10, which is received by the first communication processing module 22, and unique information of the communication device 20, which is read from the unique information storage 23, is transmitted to the first user terminal 30 via the second communication processing module 25 as described above (step S7). The unique information of the host controller 10 and the communication device 20, which is thus transmitted in step S7, is received by the first communication processing module 31 included in the first user terminal 30.

If it is assumed that the edge device is a lighting fixture as described above, a plurality of lighting fixtures may be installed in the ceiling or the like and, for example, the communication device 20 may be accidentally connected to a lighting fixture different from the lighting fixture assumed by the user. In this case, the unique information received by the first user terminal 30 (first communication processing module 31) may not be the information which the user intends. Furthermore, when wireless communication is executed between the communication device 20 and the first user terminal 30, the possibility that the first user terminal 30 (first communication processing module 31) receives the unique information prepared by a malicious third party cannot be denied.

For this reason, when the unique information of the host controller 10 and communication device 20 is received by the first user terminal 30 as described above, the unique information may be displayed on a display (display device) provided in the first user terminal 30 to prompt the user to confirm the validity of the unique information. Furthermore, for example, a one-dimensional code (bar code) or two-dimensional code (QR code (registered trademark)) attached to the host controller 10 (or an edge device incorporating the host controller 10) and the main body (housing) of the communication device 20 may be read using the camera mounted on the first user terminal 30 to obtain the unique information encoded with the code, and the validity of the unique information may be verified (confirmed) by comparing (matching) the obtained unique information with the received unique information.

Next, the second communication processing module 32 included in the first user terminal 30 transmits the unique information of the host controller 10 and the communication device 20, which is received by the first communication processing module 31, to the server device 40 via the network 60a (step S8). Incidentally, it is assumed that the second setting process for the second communication processing module 32 for the first user terminal 30 to communicate with the server device 40 has already been completed at the time when the process of step S8 is executed. In addition, in step S8, information other than the above-described unique information of the host controller 10 and the communication device 20 (for example, the location where the host controller 10 and the communication device 20 are installed, information on users who use the host controller 10 and the communication device 20, and the like) may be further transmitted.

When the process of step S8 is executed, the first communication processing module 41 included in the server device 40 receives the unique information of the host controller 10 and the communication device 20, which is transmitted in step S8.

The determination module 42 included in the server device 40 executes a process (hereinafter referred to as a connection availability determination process) of determining whether or not the communication device 20 can be connected to the host controller 10 (i.e., continuous power supply to the communication device 20 executed by the host controller 10 and the data communication between the host controller 10 and the communication device 20 are permitted), based on the unique information of the host controller 10 and the communication device 20, which is received by the first communication processing module 41, and the determination information stored in the determination information storage 43 (step S9).

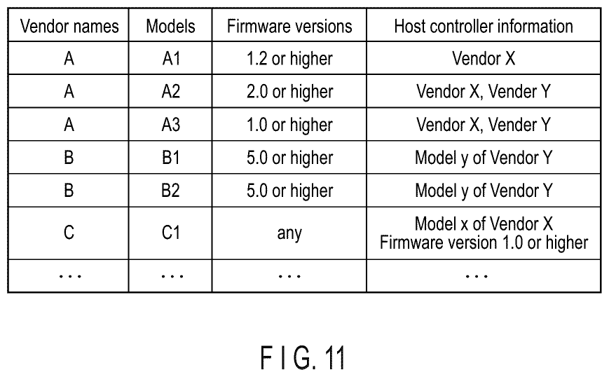

FIG. 11 shows an example of the data structure of the determination information stored in the determination information storage 43. As shown in FIG. 11, the determination information includes the vendor name, model, firmware version, and host controller information in association with each other.

The vendor name is indicative of the vendor name (name of the vendor) of the communication device 20. The model is indicative of the model of the communication device 20. The firmware version is indicative of the firmware version of the communication device 20 (i.e., version of the firmware for controlling the communication device 20). Incidentally, the vendor name, model, and firmware version are information obtained from the unique information of the communication device 20 (i.e., information unique to the communication device 20), and are considered as information for identifying the communication device 20 connected to the host controller 10.

The host controller information corresponds to the condition of the host controller that can be interconnected with the communication device 20 identified by the vendor name, model, and firmware and is represented by, for example, the vendor name and model of the host controller 10, and the firmware version of the host controller 10 (i.e., the version of the firmware for controlling the host controller 10). Incidentally, the vendor name, model, and firmware version of the host controller 10 are obtained from the unique information of the host controller 10.

In the example shown in FIG. 11, for example, the determination information including vendor name “A”, model “A1”, firmware version “1.2 or higher” and host controller information “vendor X” in association with one another is shown. According to such determination information, it is shown that the communication device 20 with vendor name “A”, model “A1”, and firmware version “1.2 or higher” is connected to the host controller 10 with vendor name “X”.

In addition, in the example shown in FIG. 11, for example, the determination information including vendor name “A”, model “A2”, firmware version “2.0 or higher”, and host controller information “vendor X, vendor Y” in association with one another is shown. According to such determination information, it is shown that the communication device 20 with vendor name “A”, model “A2”, and firmware version “2.0 or higher” can be connected to the host controller 10 with vendor name “X” or “Y”.

In addition, in the example shown in FIG. 10, for example, the determination information including vendor name “A”, model “A3”, firmware version “1.0 or higher”, and host controller information “vendor X, vendor Y” in association with one another is shown. According to such determination information, it is shown that the communication device 20 with vendor name “A”, model “A3”, and firmware version “1.0 or higher” can be connected to the host controller 10 with vendor name “X” or “Y”.

In addition, in the example shown in FIG. 11, for example, the determination information including vendor name “B”, model “B1”, firmware version “5.0 or higher”, and host controller information “model y of vendor Y” in association with one another is shown. According to such determination information, it is shown that the communication device 20 with vendor name “B”, model “B1”, and firmware version “5.0 or higher” can be connected to the host controller 10 with vendor name “Y” and model “y”.

In addition, in the example shown in FIG. 11, for example, the determination information including vendor name “B”, model “B2”, firmware version “5.0 or higher”, and host controller information “model y of vendor Y” in association with one another is shown. According to such determination information, it is shown that the communication device 20 with vendor name “B”, model “B2”, and firmware version “5.0 or higher” can be connected to the host controller 10 with vendor name “Y” and model “y”.

In addition, in the example shown in FIG. 11, for example, the determination information including vendor name “C”, model “C1”, firmware version “any”, and host controller information “model x of vendor X, firmware version of 1.0 or higher” in association with one another is shown. According to such determination information, it is shown that the communication device 20 with vendor name “C” and model “C1” can be connected to the host controller 10 with vendor name “X”, model “x”, and firmware version “1.0 or higher”. Incidentally, the firmware version “any” indicates that the firmware version is not specified (and may be any version).

According to the above-described determination information, the availability of connection of various communication devices 20 to the host controller 10 can be determined.

The connection availability determination process executed using the above-described determination information will be simply described below. First, the determination module 42 obtains the vendor name, model, and firmware version of the communication device 20 from the unique information of the communication device 20, which is received by the first communication processing module 41, and checks the host controller information (i.e., the condition of the connectible host controller) included in the determination information in association with the obtained vendor name, model, and firmware version, against the unique information of the host controller 10, which is received by the first communication processing module 41. In this case, the determination module 42 determines that the communication device 20 can be connected to the host controller 10 when the unique information of the host controller 10 matches the host controller information (i.e., the condition of connectible host controller is met).

More specifically, in the example shown in FIG. 11, for example, if it is assumed that vendor name “A”, model “A1”, and firmware version “1.2 (or higher)” are obtained from the unique information of the communication device 20, it is determined that the communication device 20 can be connected to the host controller 10 when the vendor name in the unique information of the host controller 10 is “X”.

In contrast, the determination module 42 determines that the communication device 20 cannot be connected to the host controller 10 when the unique information of the host controller 10 does not match the host controller information included in the determination information in association with the vendor name, model, and firmware version obtained from the unique information of the communication device 20 (i.e., the condition of connectible host controller is not met).

In other words, the determination information in the present embodiment is considered as information which indicates the combination of the host controller 10 and communication device 20 that are interoperable (i.e., the communication device 20 that is a legitimate device for the host controller 10).

Incidentally, the data structure of the determination information has been described with reference to FIG. 11, but the data structure of the determination information may be different from that in FIG. 11. In addition, the server device 40 in the present embodiment may be configured to determine whether or not the communication device 20 can be connected to the host controller 10 based on the unique information of the host controller 10 and the communication device 20, and the above-described connection availability determination process may be a process other than the described process.

When the process of step S9 is executed, the determination module 42 reads, for example, a private key of the server device 40 (i.e., a private key for the server device 40 generated based on a public key cryptography) from the key information storage 44, and generates the electronic signature attached to the connection availability information including the result of the process in step S9 (i.e., the determination result of the connection availability determination process) using the private key of the server device 40 (step S10). Incidentally, the electronic signature is generated by, for example, executing an encryption process for a hash value of the connection availability information calculated by the determination module 42, using the private key of the server device 40.

When the process of step S10 is executed, the first communication processing module 41 transmits the connection availability information to which the electronic signature generated in step S10 is attached, to the first user terminal 30 (step S11).

The connection availability information transmitted in step S11 is received by the second communication processing module 32 included in the first user terminal 30 and is transmitted (transferred) to the communication device 20 by the first communication processing module 31 (step S12).

Similarly, the connection availability information transmitted in step S12 is received by the second communication processing module 25 included in the communication device 20 and is transmitted (forwarded) to the host controller 10 by the first communication processing module 22 (step S13).

The connection availability information transmitted in step S13 is received by the communication processing module 12 included in the host controller 10. The authentication processing module 15 verifies the electronic signature attached to the connection availability information received by communication processing module 12 (step S14).

It is assumed that the electronic signature attached to the connection availability information is generated by encrypting the hash value of the relevant connection availability information with the private key of the server device 40, as described above. In this case, the public key (public key of the server device 40) paired with the private key of the server device 40 is stored in advance in the key information storage 16 included in the host controller 10. In step S14, for example, a process of calculating the hash value of the connection availability information received by the communication processing module 12, and checking the calculated hash value against the result of encrypting the electronic signature attached to the connection availability information with the public key of the server device 40, is executed.

When the hash value of the connection availability information matches the hash value obtained from the electronic signature (i.e., the verification of the electronic signature is successful) in step S14 described above, the device control module 13 processes the content of the determination result included in the connection availability information and controls power supply from the host controller 10 to the communication device 20 (step S15).

More specifically, when the connection availability information includes the determination result that the communication device 20 can be connected to the host controller 10, the device control module 13 instructs the power supply control module 11 to continue supplying power to the communication device 20 in order to permit connection with the communication device 20. According to this, the power supply control module 11 continues supplying power to the communication device 20, and the communication between the host controller 10 and the communication device 20 is maintained.

In contrast, when the connection availability information includes a determination result that the communication device 20 cannot be connected to the host controller 10, the device control module 13 instructs the power supply control module 11 to stop supplying power to the communication device 20 in order to reject the connection with the communication device 20. According to this, the power supply control module 11 stops supplying power to the communication device 20, and the communication between the host controller 10 and the communication device 20 is disconnected (cancelled).

According to the above-described connection process, various communication devices 20 can be easily and safely connected to the host controller 10. In other words, in the present embodiment, connecting the only appropriate communication device 20 to the host controller 10 (i.e., operating the host controller 10 in association with an authenticated communication device 20) can be realized.

Incidentally, the connection availability information may include, for example, expiration date information indicative of the expiration date of the connection availability information. According to this, for example, when the expiration date indicated by the expiration date information included in the connection availability information has expired, the device control module 13 is set to discard the connection availability information and instruct the power supply control module 11 to stop supplying power from the host controller 10 to the communication device 20. The (expiration date indicated by) this expiration date information is specified (set) in, for example, the server device 40.

In addition, even when the power supply to the communication device 20, which is executed by the power supply control module 11, is stopped as described above, the server device 40 may be urged to execute the connection availability determination process again by temporarily resuming the power supply after a certain period of time.

Incidentally, if the hash value of the connection availability information does not match the hash value obtained from the digital signature (i.e., the verification of the digital signature fails) in step S14, the device control module 13 is set to discard the connection availability information and, for example, instruct the power supply control module 11 to stop supplying power to the communication device 20.

Although omitted in FIG. 10, the verification of the electronic signature attached to the above-described connection availability information (i.e., the process in step S14) may be executed in, for example, the communication device 20. To execute this verification of the electronic signature in the communication device 20, the public key of the server device 40 may be held in advance in the communication device 20. In a case where the electronic signature attached to the connection availability information is verified in the communication device 20 as described above, the process in step S13 and subsequent processes are executed if the verification is successful or the connection availability information is discarded and the processes shown in FIG. 10 are ended if the verification fails.

Furthermore, it has been described with reference to FIG. 10 that the electronic signature is attached to the connection availability information, but the electronic signature may be attached to the unique information of the host controller 10. The electronic signature attached to the unique information of the host controller 10 can be generated in the host controller 10 using, for example, the private key of the host controller 10 that is stored in advance in the key information storage 16 included in the host controller 10. In this case, the public key of the host controller 10 is stored in advance in the key information storage 44 included in the server device 40, and the verification of the electronic signature attached to the unique information of the host controller 10 is executed using the public key of the host controller 10 before the process of step S9 is executed. According to the configuration in which the electronic signature attached to the unique information of the host controller 10 is verified in the server device 40, the process in step S9 and subsequent processes are executed if the verification is successful or the unique information is discarded and the process shown in FIG. 10 is ended if the verification fails.

Similarly, an electronic signature may be attached to the unique information of the communication device 20. The electronic signature attached to the unique information of the communication device 20 can be generated by the communication device 20 using the private key of the communication device 20 held in advance in the communication device 20. In this case, the public key of the communication device 20 is stored in advance in the key information storage 44 included in the server device 40, and the verification of the electronic signature attached to the unique information of the communication device 20 is executed using the public key of the communication device 20 before the process of step S9 is executed. According to the configuration in which the electronic signature attached to the unique information of the communication device 20 is verified in the server device 40, the process in step S9 and subsequent processes are executed if the verification is successful or the unique information is discarded and the process shown in FIG. 10 is ended if the verification fails.

Incidentally, it has been described that the electronic signature is attached to the connection availability information and the unique information but, in the present embodiment, the electronic signature (and verification of the electronic signature) may be omitted.

By the way, when the communication between the host controller 10 and the communication device 20 is maintained (i.e., the connection between the host controller 10 and the communication device 20 is permitted) by executing the process shown in FIG. 10, the device information based on the unique information of the host controller 10 and the communication device 20 is stored in the device information storage 48 included in the server device 40.

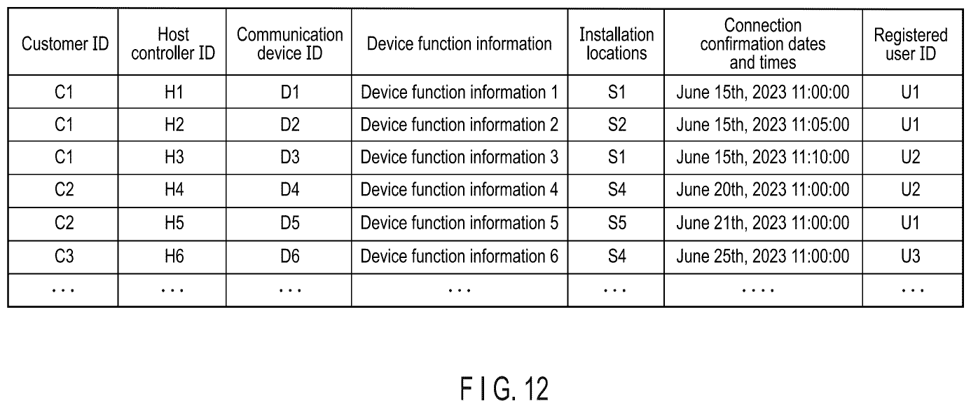

FIG. 12 shows an example of the data structure of the device information stored in the device information storage 48. As shown in FIG. 12, the device information includes customer ID, host controller ID, communication device ID, device function information, installation location, connection confirmation date and time, and registered user ID in association with one another.

The customer ID is identification information for identifying the customer who manages the edge device (or the site where the edge device is installed). The host controller ID is identification information for identifying the host controller 10 installed in the edge device managed by the customer identified by the customer ID. The communication device ID is identification information for identifying the communication device 20 that is permitted to communicate with the host controller 10 identified by the host controller ID. The device function information is device function information (i.e., information on the device function) included in the unique information of the communication device 20 identified by the communication device ID, and includes the above-described function information, setting information, and the like for application communication. The installation location is information indicative of the location (site) where the host controller 10 identified by the host controller ID and the communication device 20 identified by the communication device ID are installed. The connection confirmation date and time is the date and time when the connection between the host controller 10 identified by the host controller ID and the communication device 20 identified by the communication device ID is permitted (confirmed). The registered user ID is identification information for identifying the user who has used the first user terminal 30 when the connection between the host controller 10 and the communication device 20 identified by the communication device ID is permitted (i.e., the above-described process in FIG. 10 is executed).

The above-described device information is considered as the connection management information for managing the connection between the host controller 10 and the communication device 20 mounted in the edge device installed at each customer site.

Incidentally, in the example shown in FIG. 12, it has been described that the device information includes the device function information included in the unique information of the communication device 20 (i.e., the device function information is provided by the communication device 20) but, for example, at least part of the device function information may be managed (set) in advance in the server device 40. The device function information has been described here, but the information included in the device information may be provided by the host controller 10 or communication device 20 or may be managed (set) in advance in the server device 40.

In addition, the connection information may further include the model, firmware version, and the like included in the unique information of the host controller 10 and communication device 20, which are omitted in FIG. 12.

Furthermore, for example, when the (information on) installation location shown in FIG. 12 is the information that is managed in advance in the server device 40, the installation location may be provided (notified) to the communication device 20 identified by the communication device ID as the information to be set in the communication device 20. According to this, the communication device 20 can register (set) the (information on) location where the (host controller 10 connected to) communication device 20 is installed, in the communication device 20.

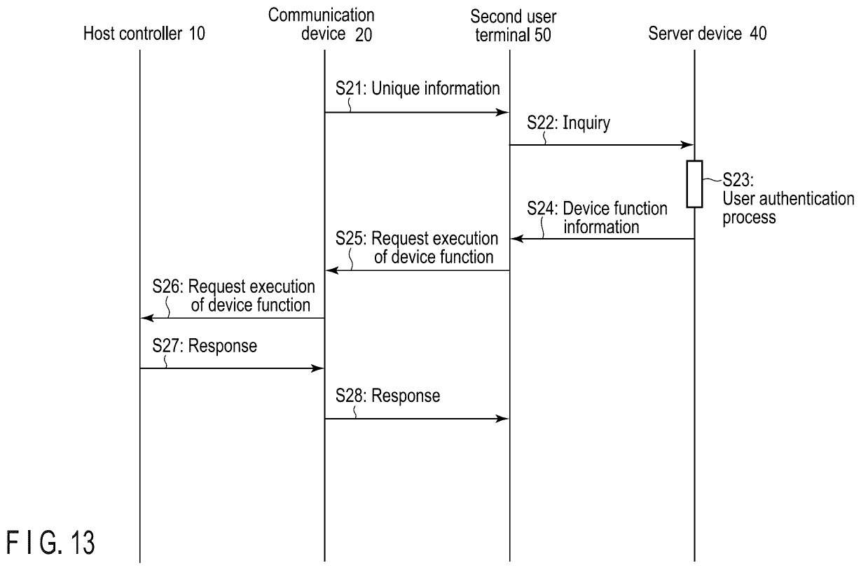

Next, an example of a procedure of the above-described device function execution process will be described with reference to a sequence chart of FIG. 13. It is assumed that the connection between the host controller 10 and the communication device 20 is permitted by executing the process in FIG. 10.

First, when the second user terminal 50 discovers the communication device 20, the first communication processing module 51 included in the second user terminal 50 communicates with the (second communication processing module 25 included in) communication device 20 and receives the unique information of the communication device 20 transmitted by the communication device 20 (step S21). It is assumed that the unique information of the communication device 20 received in step S21 is, for example, the communication device ID for identifying the communication device 20.

Incidentally, the process of step S21 is executed when the second user terminal 50 discovers the communication device 20. For example, when the communication with the communication device 20 based on Bluetooth is executed, the second user terminal 50 can discover the communication device 20 by receiving data that is periodically transmitted by the communication device 20 within the communication range of the communication device 20.

However, the communication device 20 may be discovered by other methods. More specifically, the communication device 20 may be discovered when a code (i.e., one-dimensional or two-dimensional code) attached to the body (housing) of the communication device 20 is read using a camera mounted on the second user terminal 50. In this case, the unique information of the communication device 20 may be obtained by reading the code attached to the body of the communication device 20.

Next, the application processing module 53 included in the second user terminal 50 makes an inquiry on the device function by transmitting to the server device 40 the user ID for identifying the user using the second user terminal 50, the password assigned (set) to the user, and the unique information of the communication device 20 received by the first communication processing module 41 (step S22).

The second communication processing module 45 included in the server device 40 receives the user ID, password, and unique information of the communication device 20 transmitted from the second user terminal 50 as described above. The providing module 46 included in the server device 40 executes a process (hereinafter referred to as a user authentication process) of determining whether or not the user using the second user terminal 50 is a user capable of executing the device function (i.e., the user of the second user terminal 50 is an authenticated user to execute the functions of the communication device 20), based on the user ID, password, and unique information of the communication device 20 received by the second communication processing module 45 and the user information stored in the user information storage 47 (step S23).

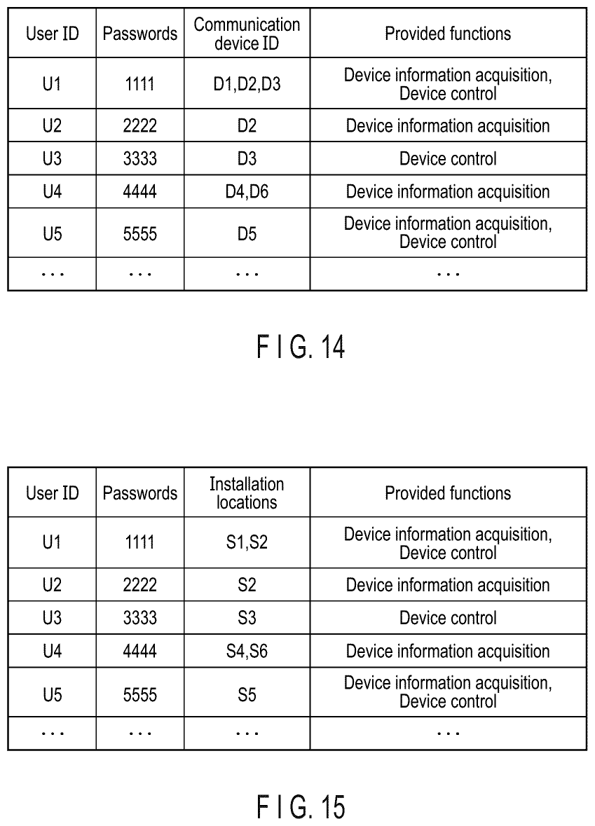

FIG. 14 shows an example of the data structure of the user information stored in the user information storage 47. As shown in FIG. 14, the user information includes a user ID, password, communication device ID, and provided functions in association with one another.

The user ID is identification information for identifying a user using the second user terminal 50. The password is a password assigned (set) to the user identified by the user ID. The communication device ID is identification information for identifying the communication device 20 on which the user identified by the user ID can execute functions. The provided functions are indicative of the device functions based on the communication device ID (i.e., functions provided by the communication device 20 identified by the communication device ID).

In the example shown in FIG. 14, the provided functions include functions of “device information acquisition” and “device control”. For examples, the “device information acquisition” intends a function to acquire the information from the communication device 20. In addition, the “device control” intends a function to control the communication device 20.

In the example shown in FIG. 14, only the “device information acquisition” and the “device control” are shown as provided functions, but the provided functions include various functions. More specifically, the provided functions may include “host control”, which is a function to control the (edge device incorporating) host controller 10 to which the communication device 20 is connected, “device actuator control”, which is a function to control an actuator built in the communication device 20, “host sensor data acquisition”, which is a function to acquire sensor data from sensors connected to the host controller 10, and “device sensor data acquisition”, which is a function to acquire sensor data from sensors connected to the communication device 20, and the like.

In addition, the user information in the present embodiment may be information used for the user authentication process, may include information other than the information described with reference to FIG. 14, or some of the information described with reference to FIG. 14 may be omitted.

The user authentication process executed using the above-described user information will be described below in brief. First, the providing module 46 determines whether or not the user information that includes the user ID and the password received by the second communication processing module 45 in association with each other (hereinafter referred to as “target user information”) is stored in the user information storage 47. If it is determined that the target user information is stored in the user information storage 47, the providing module 46 checks the communication device ID received by the second communication processing module 45 against the communication device ID included in the target user information. Incidentally, if authentication is executed by not using the user ID and the password, but using a user certificate, the communication device ID associated with the user may be identified by using the information on the user certificate and the user's authorization information (token) received by the second communication processing module 45. Although details are omitted, the information held in the user information storage 47 may include information other than that described with reference to FIG. 14 as described above or some parts of the information described with reference to FIG. 14 may be omitted.

If the communication device ID received by the second communication processing module 45 matches the communication device ID included in the target user information, the providing module 46 determines that the user using the second user terminal 50 is a user capable of executing the device function based on the communication device ID and permits execution of the device function (i.e., providing the device function information).

In contrast, if the communication device ID received by the second communication processing module 45 does not match the communication device ID included in the target user information, the providing module 46 determines that the user using the second user terminal 50 is not a user capable of executing the device function based on the communication device ID, and rejects execution of the device function (i.e., providing the device function information).

Incidentally, it has been described that the user authentication process is executed based on the user information shown in FIG. 14, but the user authentication process may be executed based on user information different from that shown in FIG. 14. More specifically, the user authentication process can be executed based on, for example, the user information shown in FIG. 15. The user information shown in FIG. 15 includes the installation locations instead of the communication device ID of the user information shown in FIG. 14.

The user authentication process executed using the user information shown in FIG. 15 will be described below in brief. It is assumed that the unique information of the communication device 20 received in step S21 is the installation locations of the communication device 20.

In this case, the providing module 46 determines whether or not the user information (target user information) including the user ID and password received by the second communication processing module 45 in association with each other is stored in the user information storage 47. If it is determined that the target user information is stored in the user information storage 47, the providing module 46 checks the installation location received by the second communication processing module 45 against the installation location included in the subject user information.

If the installation location received by the second communication processing module 45 matches the installation location included in the target user information, the providing module 46 determines that the user using the second user terminal 50 is a user capable of executing the device function based on the installation location (i.e., a function provided by the communication device installed at the installation location), and permits execution of the device function.

If the installation location received by the second communication processing module 45 does not match the installation location included in the target user information, the providing module 46 determines that the user using the second user terminal 50 is not a user capable of executing the device function based on the installation location, and rejects execution of the device function.

Incidentally, it has been described that the unique information of the communication device 20 is the installation location of the communication device 20 when the user authentication process is executed based on the user information shown in FIG. 15, but the installation location of the communication device 20 may be acquired from, for example, the device information including the communication device ID received as the unique information of the communication device 20.

If the execution of the device function is rejected as a result of the above-described user authentication process, the process shown in FIG. 13 is ended.

In contrast, if the execution of the device function is permitted, the providing module 46 reads from the device information storage 48 the device function information included in the device information in association with the unique information (for example, communication device ID) of the communication device 20, which is received by the second communication processing module 45. The providing module 46 provides (transmits) the device function information read from the device information storage 48 to the second user terminal 50 via the second communication processing module 45 in response to the inquiry made in step S22 (step S24).

Next, the second communication processing module 52 included in the second user terminal 50 receives the device function information provided by the server device 40. The application processing module 53 stores the device function information received by the second communication processing module 52 in the device function information storage 54.

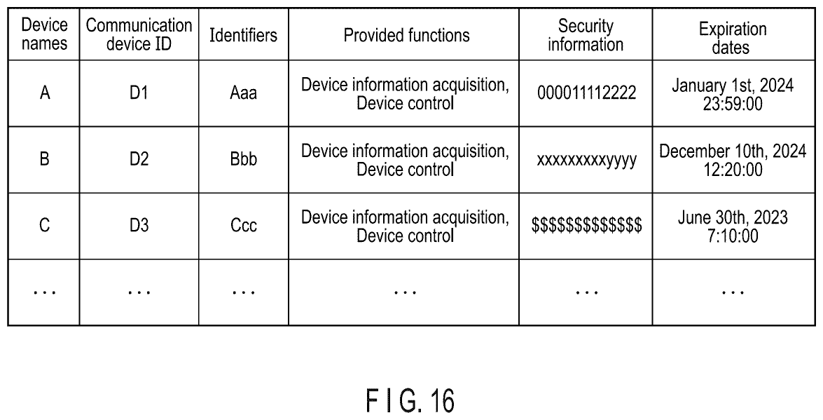

FIG. 16 shows an example of the data structure of the device function information stored in the device function information storage 54. As shown in FIG. 16, the device function information includes, for example, the device names, communication device ID, identifiers, provided functions, security information, and expiration dates in association with one another.

The device name is a device name of the communication device 20 (name of the communication device 20). The communication device ID is identification information for identifying the communication device 20. The identifier is, for example, identification information for identifying a network for accessing the communication device 20. The provided function is indicative of the device function based on the communication device ID. The security information is information on the security used to access the communication device 20. The expiration date is a time limit for executing the device function based on the device function information.

Incidentally, it is assumed that the security information, for example, included in the device function information in the present embodiment is obtained from the communication device 20, but the security information may be the information generated by the server device 40 for the (user using) second user terminal 50 that executes the device function. In this case, it is assumed that the communication device 20 is notified of the security information from the server device 40 via the first user terminal 30 as the information to be set in the communication device 20 and the security information is set in the communication device 20.

In addition, a plurality of elements of the device function information can be stored in the device function information storage 54, and the device function information that has expired is assumed to be discarded (deleted) in the device function information storage 54. Discard of the device function information may be executed automatically based on the expiration date or may be executed by the application processing module 53 at the timing of referring to the device function information storage 54. The expired device function information (entries) may be updated by the application processing module 53 making an inquiry again to the server device 40.

The expiration date may be specified (set) by the server device 40 that provides the device function information, specified (set) by the second user terminal 50 to which the device function information is provided, or specified (set) by the communication device 20.

In addition, it has been described that the device function information includes the device names, communication device ID, identifiers, provided functions, security information, and expiration dates, but the device function information may include information other than these information or some parts of the information may be omitted.

In addition, the identifiers and security information shown in FIG. 16 correspond to the above-described setting information for application communication, but the setting information for application communication may further include the address, port number, URL and the like of the communication device 20.

Description returns again to FIG. 13 and, the application processing module 53 reads from the device function information storage 54, for example, the device function information including the unique information (for example, communication device ID) of the communication device 20 received in step S21, and requests the communication device 20 to execute the device function based on the device function information (step S25).

In step S25, for example, the identifier and security information included in the above-described device function information are transmitted from the second user terminal 50 to the communication device 20 as information for accessing the communication device 20 and executing the device function.

In addition, in step S25, for example, the communication device 20 may also be requested to execute a part of the device function.

The second communication processing module 25 included in the communication device 20 accepts the request in step S25. The device processing module 24 included in the communication device 20 processes the request accepted by the second communication processing module 25 and operates in response to the request. In this case, for example, the device processing part 24 may control the communication device 20 to realize providing the device function, may control an actuator built in the communication device 20, or may acquire sensor data from a sensor connected to the communication device 20.

Incidentally, for example, if it is necessary to operate the (edge device incorporating) host controller 10 as a device function, the device processing section 24 requests the host controller 10 to execute the device function (step S26).

The communication processing module 12 included in the host controller 10 accepts the request in step S26. The device control module 13 included in the host controller 10 processes the request accepted by the communication processing module 12 and operates in response to the request. In this case, the device control module 13 may control the edge device incorporating the host controller 10 to realize providing the device function or may acquire sensor data from a sensor connected to the host controller 10.

When the device control module 13 processes a request from the communication device 20 as described above, the device control module 13 returns a response (message) to the request to the communication device 20 via the communication processing module 12 (step S27).

Furthermore, if the device processing module 24 processes a request from the second user terminal 50, the device processing module 24 returns a response (message) to the request to the second user terminal 50 (step S28).

According to the above-described device function execution process, it is possible to realize permitting the only (user using) second user terminal 50 authorized by the server device 40 to execute the device function (i.e., providing the device function information within the scope of permission granted to the second user terminal 50).

Incidentally, in step S21, the unique information of the communication device 20 transmitted from the communication device 20 is received at the second user terminal 50, but an electronic signature generated using the private key of the communication device 20 may be attached to the unique information of the communication device 20, and the process (authentication process) of verifying the electronic signature using the public key of the communication device 20 may be executed at the second user terminal 50.

Similarly, in step S22, the user ID, passwords, and unique information of the communication device 20 are transmitted from the second user terminal 50 to the server device 40, but the electronic signature generated using the private key of the second user terminal 50 may be attached to the user ID and passwords, and the unique information of the communication device 20, and the process (authentication process) of verifying the electronic signature using the public key of the communication device 20 may be executed at the server device 40.

Furthermore, in step S24, the device function information is transmitted from the server device 40 to the second user terminal 50, but an electronic signature generated using the private key of the server device 40 may be attached to the device function information, and the process of verifying the electronic signature using the public key of the server device 40 may be executed at the second user terminal 50.

In addition, in step S25, for example, the identifier and the security information included in the device function information are transmitted from the second user terminal 50 to the communication device 20, but the electronic signature generated using the private key of the second user terminal 50 may be attached to the identifier and the security information, and the process of verifying the electronic signature using the public key of the second user terminal 50 may be executed at the communication device 20.

Incidentally, although detailed explanations are omitted, but an authentication process other the above-described process may be executed or a process such as encryption and decryption may be executed for the data on the communication, in the communication executed in the above-described connection process and device function execution process (for example, communication between the communication device 20 and the first user terminal 30 and second user terminal 50, communication between the first user terminal 30 and second user terminal 50 and the server device 40, and the like).

In the process shown in FIG. 13, it has been described that the device function is executed when the second user terminal 50 discovers the communication device 20, but the (device processing module 24 included in) the communication device 20 is assumed to have a function (hereinafter described as an advertisement function) to make advertisement on the communication device 20 or the device function for the second user terminal 50. According to this advertisement function, a screen corresponding to the advertisement made by the communication device 20 (hereinafter referred to as an advertisement screen) can be displayed on the second user terminal 50.

A specific example of the advertisement screen in the present embodiment will be described below. It is assumed that the edge device incorporating the host controller 10 is a lighting fixture. In addition, the advertisement screen is displayed by, for example, the application processing module 53 (i.e., a device control application running on the second user terminal 50).

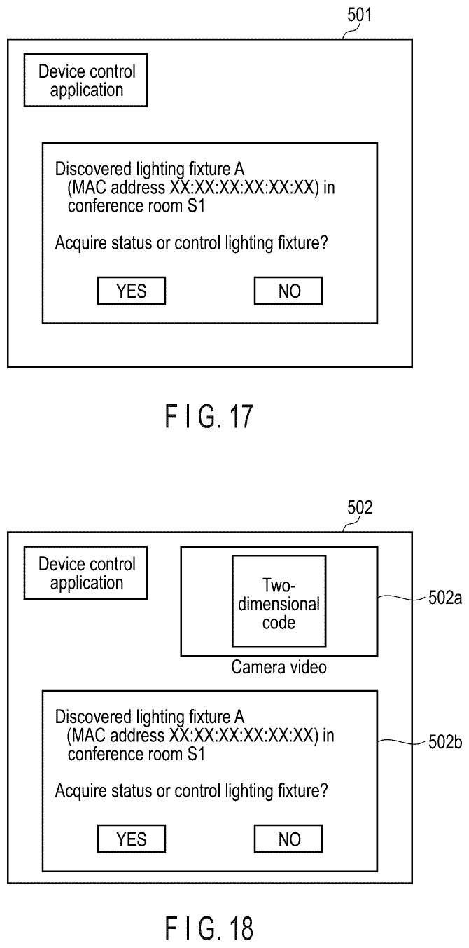

First, FIG. 17 shows an example of the advertisement screen displayed on the second user terminal 50, for example, when the second user terminal 50 discovers the communication device 20.

Incidentally, an advertisement screen 501 shown in FIG. 17 is displayed on the second user terminal 50, for example, after the above-described process of step S21 shown in FIG. 13 is executed.

A message (advertisement) “discovered lighting fixture A (MAC address XX: XX: XX: XX: XX: XX) in conference room S1” is displayed on the advertisement screen 501 shown in FIG. 17, and the message is generated using the MAC address included in the unique information of the communication device 20, the installation location set in the communication device 20, and the like.

In addition, a “YES” button and a “NO” button are displayed together with a message “acquire state and control the lighting fixture?” on the advertisement screen 501 shown in FIG. 17. Incidentally, this message intends to confirm whether or not to execute the device function for the user. If an operation of pressing the “Yes” button in such an advertisement screen 501 is executed by the user using the second user terminal 50, the process of step S22 shown in FIG. 13 is executed. In other words, in the present embodiment, the (user using) second user terminal 50 can make an inquiry on the device function based on the above-described advertisement.

In this case, the communication device 20 may be discovered when a code (for example, a two-dimensional code) attached to the body of the communication device 20 is read using a camera mounted on the second user terminal 50. FIG. 18 shows an example of an advertisement screen displayed on the second user terminal 50 when the communication device 20 is discovered by reading the code.

The advertisement screen 502 shown in FIG. 18 includes an area 502a for displaying an image of a camera for reading the code attached to the body of the communication device 20 and an area 502b for displaying a message (advertisement).

According to such an advertisement screen 502, when the code attached to the body of the communication device 20 is read by capturing the code (i.e., displaying the code in the area 502a) with the camera mounted on the second user terminal 50, a message similar to the above-described message shown in FIG. 17 can be displayed in the area 502b.

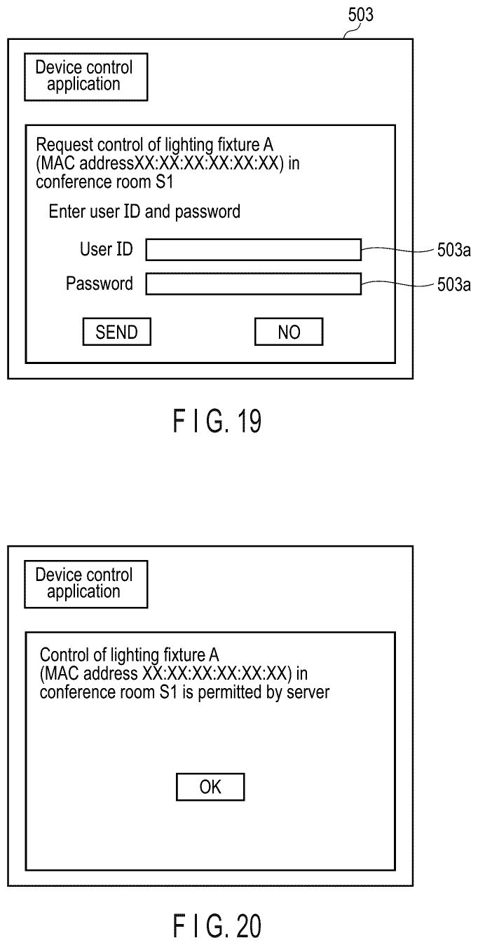

Furthermore, in step S22 shown in FIG. 13, the user ID and the password need to be transmitted from the second user terminal 50 to the server device 40. For this reason, the advertisement screen 501 or 502 is set to transition to an advertisement screen shown in FIG. 19 when the “YES” button is pressed in the above-mentioned advertisement screen 501 or 502.

The advertisement screen 503 shown in FIG. 19 includes a first input area 503a for entering a user ID and a second input area 503b for entering a password.

The second user terminal 50 is set to transmit the user ID and the password to the server device 40 in response to an operation to press a “SEND” button (i.e., to make an inquiry on the device function) when the user ID is entered in the first input area 503a and the password is entered in the second input area 503b.

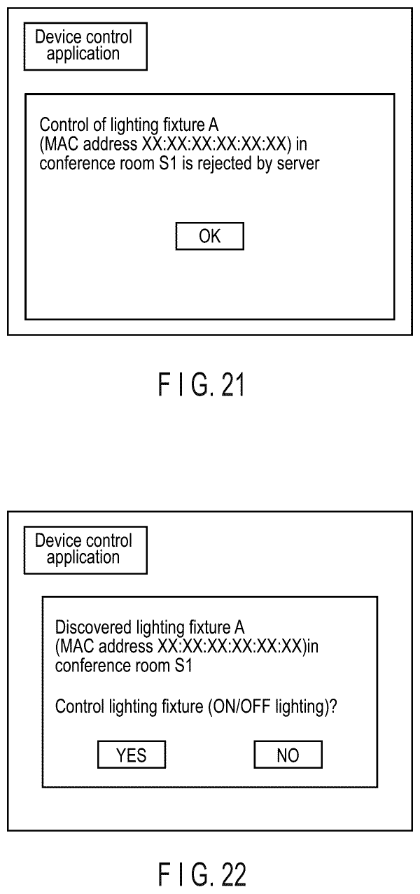

In addition, in the above-described process of step S23 (user authentication process) shown in FIG. 13, the execution of the device function (providing the device function information) can be permitted or rejected. FIG. 20 shows an example of an advertisement screen displayed on the second user terminal 50 when the execution of the device function is permitted, and FIG. 21 shows an example of an advertisement screen displayed on the second user terminal 50 when the execution of the device function is rejected.

Incidentally, the advertisement screens shown in FIG. 20 and FIG. 21 need only to be set to allow the user to understand that the execution of the device function is permitted or rejected, and messages to be displayed on the advertisement screens may be different from the messages in FIG. 20 and FIG. 21.

In addition, in the example shown in FIG. 13, it is possible to execute the device function (i.e., to request the execution of the device function) based on the device function information provided by the server device 40 by making an inquiry from the second user terminal 50 to the server device 40. The device function information is stored in the device function information storage 54 included in the second user terminal 50.

For this reason, for example, if the device function information including the unique information (for example, communication device ID) of the communication device 20, which is received in step S21, is already stored in the device function information storage 54 (i.e., permission to execute the device function based on the communication device ID is already obtained), the processes in steps S22 to S24 may be omitted and the advertisement screen shown in FIG. 22 may be displayed. When an operation of pressing the “Yes” button in the advertisement screen shown in FIG. 22 is executed, the process of step S25 is executed. Incidentally, it is assumed that in the advertisement screen shown in FIG. 22, the device function is a function to control ON/OFF of the lighting fixture (edge device).

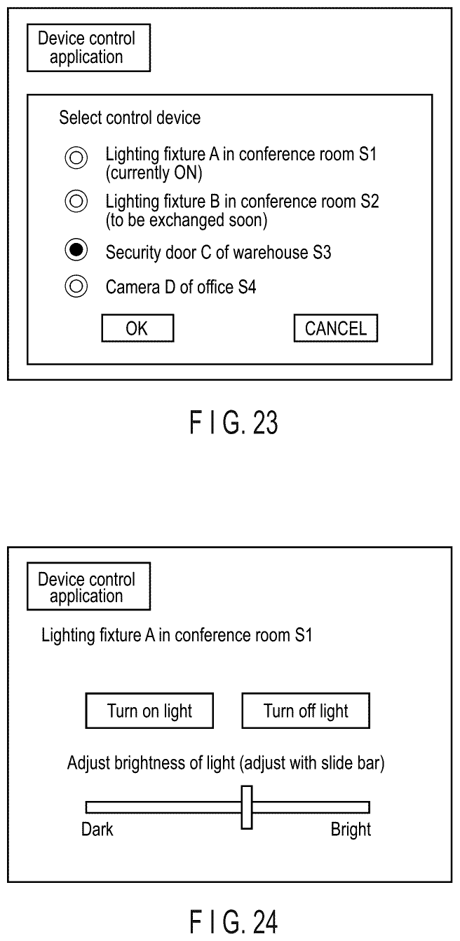

Furthermore, it has been described that in the present embodiment, for example, the device function is executed with the communication device 20 identified based on the unique information of the communication device 20, which is received in step S21. For example, an advertisement screen on (the device name and the like included in) a plurality of elements of the device function information as shown in FIG. 23 may be displayed and the user using the second user terminal 50 may select the communication device 20 that executes the device function on the advertisement screen.

Furthermore, FIG. 24 shows an example of the advertisement screen for executing the device function. It is assumed that in the advertisement screen shown in FIG. 24, the device function is a function not only to turn ON/OFF of the lighting fixture, but also to control (adjust) the brightness of the lighting fixture.

By the way, it has been described that when the communication device 20 is discovered, the second user terminal 50 receives the unique information of the communication device 20 from the communication device 20. The second user terminal 50 may receive information (hereinafter referred to as additional information) on the communication device 20 or (the edge device incorporating) the host controller 10 connected to the communication device 20 in addition to the unique information of the communication device 20. The information on the status of the communication device 20 or the host controller 10 is considered as the additional information.

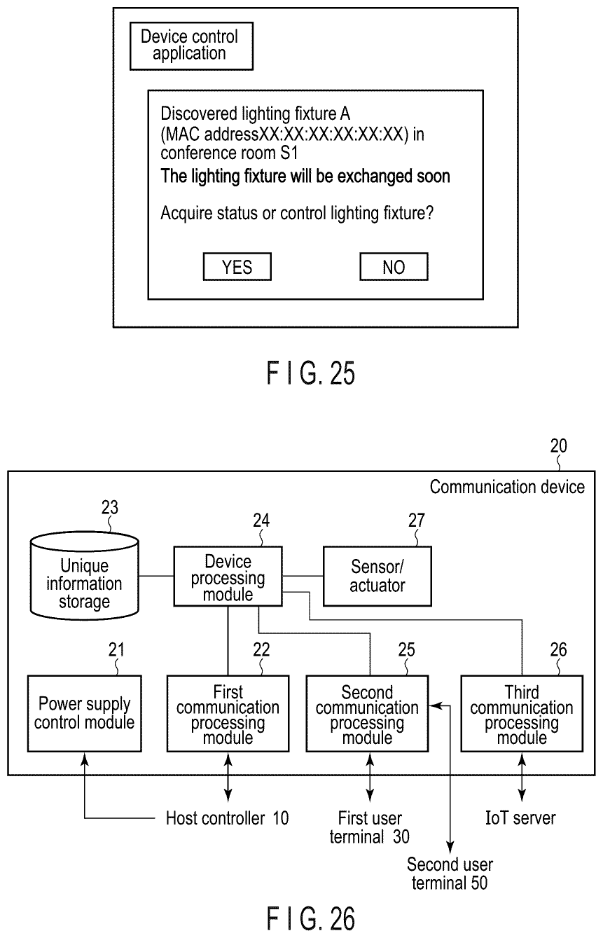

In this case, a message such as “this lighting fixture will be exchanged soon” as shown in, for example, FIG. 25 can be displayed on the advertisement screen by the communication device 20 transmitting the above-described additional information (for example, making an advertisement on broadcast). Therefore, the user using the second user terminal 50 can easily recognize the status of the communication device 20 or the host controller 10 (edge device). Messages “currently turned on” and “exchanged soon” in the advertisement screen shown in FIG. 23 are also examples of the messages based on the additional information.

Incidentally, the additional information may be provided (transmitted) from the second user terminal 50 to the server device 40 when the second user terminal 50 makes an inquiry to the server device 40. The additional information thus provided by the second user terminal 50 to the server device 40 may be used for, for example, the user authentication process. More specifically, in the case of a communication device 20 connected to a lighting fixture which is to be exchanged soon, the user authentication process to allow all users to execute the device function can be executed.

By the way, when the connection between the host controller 10 and the communication device 20 is permitted by executing the above-described process shown in FIG. 9 and when power supply from the host controller 10 to the communication device 20 continues, the edge device incorporating the host controller 10 may use the communication function of the communication device 20, and the device processing module 24 included in the communication device 20 can execute the processing according to the edge device in the IoT.

In this case, it is assumed that the communication device 20 further includes, for example, a third communication processing module 26 which communicates with an IoT server (a server device for providing IoT services) and a sensor/actuator 27, as shown in FIG. 26. FIG. 26 is a view mainly showing a functional configuration of the communication device 20, and the sensor/actuator 27 corresponds to a part of the hardware configuration of the communication device 20.

In such a configuration, for example, when the communication device 20 includes a sensor 27, the device processing module 24 can execute, for example, a process to periodically transmit sensor data measured by the sensor 27 to the IoT server via the third communication processing module 26. Incidentally, for example, the sensor data may be transmitted via the second communication processing module 25.

In addition, for example, when the communication device 20 includes an actuator 27, the device processing module 24 can receive, for example, a control signal transmitted from the IoT server via the third communication processing module 26 and execute a process to control the actuator 27 based on the control signal. Incidentally, the control signal may be a control signal to control the sensor 27 provided in the communication device 20. In addition, for example, the control signal may be received via the second communication processing module 25.

For example, in a case where the edge device is a lighting fixture, if the communication device 20 includes an actuator which drives the illuminance sensor and LED, inconvenience of the lighting fixture, and the like can be monitored by transmitting the illuminance (sensor data) measured by the illuminance sensor to the IoT, and the lighting fixture (LED) can be remotely dimmed by controlling the actuator based on the control signal transmitted from the IoT server, according to the processing executed by the above-described device processing module 24.

It has been described that the edge device is the lighting fixture and that the sensor/actuator 27 is the actuator which drives the illuminance sensor and the LED (illumination), but the edge device may be any device other than the lighting fixture. In addition, the sensor 27 may be, for example, a temperature sensor, a humidity sensor, a carbon dioxide (CO2) concentration sensor, an image sensor (camera), or the like, and the actuator 27 may be an actuator which drives a speaker, a camera, a robot arm, or the like.

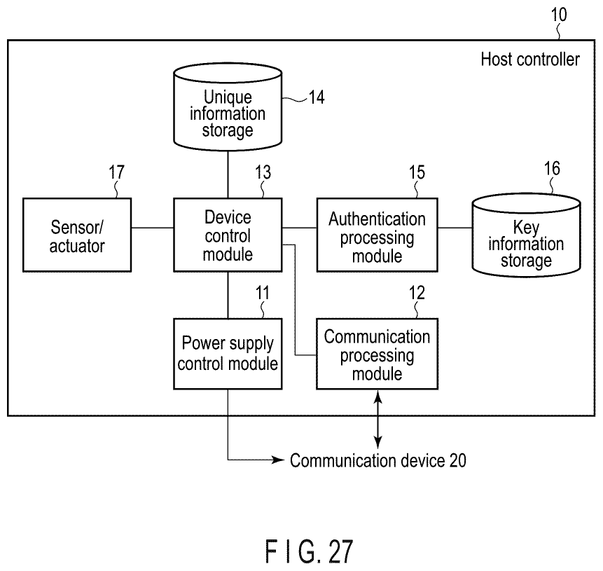

Furthermore, it has been described that the sensor/actuator includes the communication device 20, but the host controller 10 (edge device) may include a sensor/actuator 17 as shown in FIG. 27. Even in such a configuration, the sensor data measured by the sensor 17 can be transmitted from the communication device 20 to the IoT server, and the actuator (or sensor) 17 can be controlled by the communication device 20 (IoT server). FIG. 27 is a view mainly showing the functional configuration of the host controller 10, and the sensor/actuator 17 corresponds to a part of the hardware configuration of the host controller 10.

Incidentally, when the connection between the host controller 10 and the communication device 20 is permitted as described above, for example, setting information on the third communication processing module 26 may be provided from the first user terminal 30 to the communication device 20. The setting information includes, for example, identification information (identifier) which is to be set in the third communication processing module 26 to communicate with the above-described IoT server, identification information of the network to which the communication device 20 is connected or the network constituted by the communication device 20, and the like. In addition, when the communication device 20 and the IoT server execute wireless communication, the above-described setting information may include information such as radio frequency and channel for the wireless communication. Such setting information may be provided according to the user operation (input information) for the first user terminal 30 or may be provided by the server device 40.

As described above, in the communication system 1 of the present embodiment, when the second user terminal 50 (terminal device) discovers the communication device 20 connected to the host controller 10 (i.e., the controller provided in the edge device), the server device 40 provides the second user terminal 50 with the device function information on the device function (i.e., the function provided by the communication device 20). In addition, the second user terminal 50 requests the communication device 20 to execute the device function based on the device function information provided by the server device 40.

In the present embodiment, the device function of the communication device 20 can easily be executed using the second user terminal 50 by the configuration.

Incidentally, in the present embodiment, the second user terminal 50 makes an inquiry for the device function of the discovered communication device 20, and the server device 40 provides second user terminal 50 with the device function information in response to the inquiry.

In this case, when the inquiry is made by the second user terminal 50, the server device 40 determines whether the user is a user capable of executing the device function, based on the user information stored in the user information storage 47, and permits or rejects providing the device function information (executing the device function), based on the determination result.

In the present embodiment, the device function can be executed by only the second user terminal 50 permitted by the server device 40 for the communication device 20 connected to the host controller 10, by the above-described configuration.

Incidentally, the device function information in the present embodiment may be any information used to execute the device function or API of the communication device 20, including, for example, security information and the like.

In general, for example, when using a Wi-Fi function and the like, a user terminal needs to send the SSID and the password to a communication device such as a router. Since the communication system 1 in the present embodiment is configured to execute the device function (communication device 20) based on the device function information provided by the server device 40 as a response to the inquiry from the second user terminal 50, this configuration is different from a configuration which merely uses the Wi-Fi function.

In addition, in the present embodiment, the server device 40 receives the unique information of the host controller 10 (i.e., second unique information unique to the controller) and the unique information of the communication device 20 before the host controller 10 is connected to the communication device 20, and determines whether the communication device 20 can be connected to the host controller 10 based on the received unique information. According to this, when it is determined that the communication device 20 can be connected to the host controller 10, the server device 40 can provide the second user terminal 50 with the device function information included in the unique information of the communication device 20.

In the present embodiment, this configuration enables central control of the correspondence between the host controller 10 and the communication device 20, in the server device 40, and enables various communication devices 20 to be easily and safely connected to the host controller 10. In other words, in the present embodiment, the device function of the communication device 20 appropriately connected to the host controller 10 can be executed.

Incidentally, in the present embodiment, the host controller 10 can receive the connection availability information from the server device 40 via the communication device 20, and reject the connection of the communication device 20, based on the received connection availability information. More specifically, the host controller 10 is configured to supply power to the communication device 20, and the host computer 10 stops supplying power to the communication device 20 when rejecting the connection to the communication device 20.

Incidentally, according to the configuration, control of limiting (restricting) the communication device 20 that can be connected to the host controller 10 to the products of a specific vendor (model or firmware) can be executed, and the mechanism provided in the present embodiment can be used in a business model. Furthermore, the configuration of the present embodiment is useful as, for example, a security measure for the IoT services since a situation of connecting the communication device 20 which a malicious third party has prepared to the host controller 10 for an unauthorized purpose can be avoided.

In addition, in the present embodiment, when it is determined that the communication device 20 can be connected to the host controller 10, the communication device 20 may be notified of the information which is to be set in the communication device 20 in order to execute the device function of the communication device 20 (for example, the installation location of the communication device 20, and the like) by the server device 40. In this case, for example, when the second user terminal 50 discovers the communication device 20, the communication device 20 can make an advertisement to the second user terminal 50 based on the information set in the communication device 20. According to this, the server device 40 can provide the device function information as a response to the inquiry from the second user terminal 50 made based on the above-described advertisement (function).

Incidentally, when the connection of the communication device 20 is not rejected as described above (i.e., the connection is permitted), the host controller 10 (authentication processing module 15) may issue a token to be used for the communication executed with the communication device 20. The token thus issued is held in the host controller 10 and the communication device 20. According to such a configuration, for example, when the communication device 20 executes data communication with the host controller 10, the host controller 10 can check the token included in the data against the token held inside the host controller 10, and operate to process the data only when the token included in the data is the correct token.

More specifically, it is assumed that, for example, when the host controller 10 includes the sensor 17 as shown in FIG. 27 described above, the communication device 20 reads (i.e., receives from the host controller 10) the sensor data measured by the sensor 17. In this case, for example, the communication device 20 requests the sensor data from the host controller 10 but, if a correct token (token issued by the host controller 10) is not included in the request, the host controller 10 can reject the request (i.e., does not transmit the sensor data in response to the request).

According to this configuration, the security risk in the IoT services can be further reduced.

Incidentally, an expiration date (information) may be set for the token issued by the host controller 10. If an expiration date is thus set on the token, the token whose expiration date expires cannot be used. Therefore, when continuing the connection (communication) with the host controller 10, the communication device 20 requests the host controller 10 to issue a token for a new expiration date is set within the expiration date.

By the way, it has been described that the communication system 1 executes the processes shown in FIG. 10 in the present embodiment but, in the process shown in FIG. 10, the pairing process is executed between the communication device 20 and the first user terminal 30 after the host controller 10 and the communication device 20 are connected via the connection interface.

However, for example, a plurality of lighting fixtures are installed on the ceiling as edge devices and, executing for each edge device a work of operating the first user terminal 30 and the communication device 20 (for example, pressing predetermined buttons of the first user terminal 30 and the communication device 20) to execute the pairing process, after connecting the communication device 20 to the host controller 10 via a connection interface such as a USB connector or pin slot connector, is very complicated.

For this reason, the present embodiment may adopt a configuration in which, for example, the pairing process between the communication device 20 and the first user terminal 30 is executed in advance, and the communication device 20 that has completed the pairing process is connected to the host controller 10.

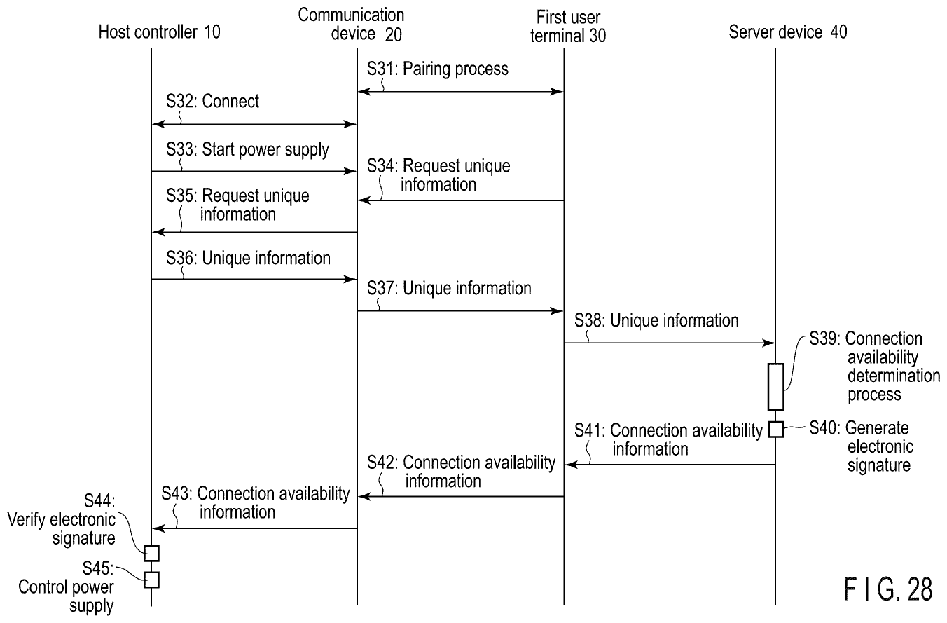

FIG. 28 is a sequence chart showing an example of the procedure of the communication system 1 (connection process) in a case of executing a pairing process between the communication device 20 and the first user terminal 30 in advance.

In this case, for example, a power supply jig including a USB connector having a power supply function is prepared, and the communication device 20 in an initialized state is connected to the power supply jig via the USB connector, and power is supplied to the communication device 20. When power is supplied to the communication device 20, the communication device 20 becomes an operable state, and the pairing process between the communication device 20 and the first user terminal 30 can be executed (step S31). Incidentally, since the process in step S31 is the same as the process in step S3 shown in FIG. 10, its detailed description will be omitted.

After the process in step S31 is executed, the processes in steps S32 to S45 corresponding to the processes in steps S1, S2, and S4 to S15 shown in FIG. 10 may be executed.

In other words, according to the processes shown in FIG. 28, pairing between the communication device 20 and the first user terminal 30 has already been completed when the communication device 20 is connected to the host controller 10. Therefore, when the host controller 10 and the communication device 20 are connected and the first user terminal 30 receives, for example, a predetermined signal transmitted from the communication device 20 (i.e., confirms that the communication device 20 becomes an operable state), the first user terminal 30 can immediately request the communication device 20 for the unique information.

In the configuration in which the pairing process between the communication device 20 and the first user terminal 30 is executed in advance as described above, the pairing process in the communication system 1 of the present embodiment can be executed efficiently and the user's convenience can be improved.

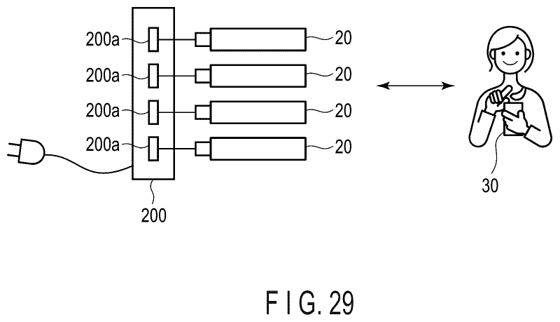

In addition, for example, if a power supply jig 200 including a plurality of USB connectors 200a is prepared as shown in FIG. 29, pairing to a plurality of communication devices 20 connected to a plurality of edge devices (host controller 10 mounted on each of the edge devices) can be executed sequentially, and the efficiency of the pairing process can be further improved.

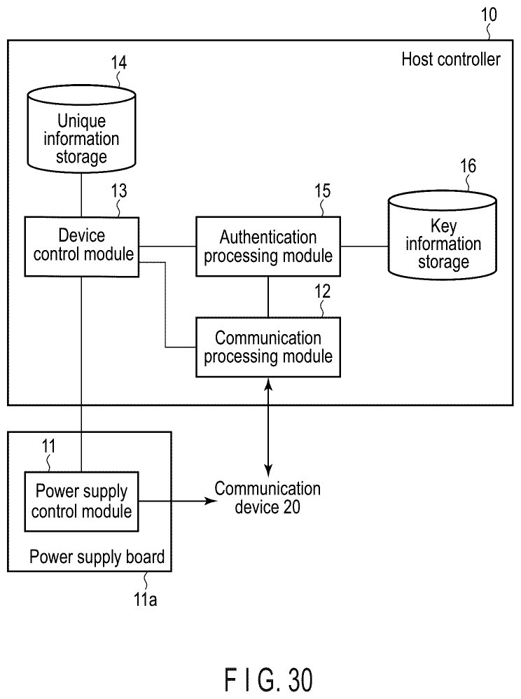

Incidentally, in the present embodiment, it has been described that the host controller 10 including the power supply control module 11 is mounted on the edge device as shown in FIG. 2, but the edge device may be configured such that the power supply board 11a including the power supply control module 11 is prepared separately from the host controller 10 (in other words, the power supply control module 11 is mounted on a board different from that of the host controller 10) as shown in FIG. 30. Even in such a configuration, the power supply control module 11 can supply power to the communication device 20 in response to instructions (control) from the device control module 13. Incidentally, for example, the edge device may have a configuration in which the host controller 10 is incorporated in the power supply board 11a or may have other configurations.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication system comprising a server device and a terminal device connected to the server device via a network, wherein
the server device comprises a first processor configured to provide the terminal device with device function information on a function provided by a communication device when the terminal device discovers the communication device connected to a controller provided in an edge device, and
the terminal device comprises a second processor configured to request the communication device to execute a function provided by the communication device, based on the provided device function information.

2. The communication system of claim 1, wherein
the second processor is further configured to inquire the function provided by the discovered communication device, and
the first processor is further configured to provide the terminal device with the device function information in response to the inquiry.

3. The communication system of claim 2, wherein
the server device further comprises a storage configured to store user information indicative of a user capable of executing the function provided by the communication device, and
the first processor is further configured to determine whether the user using the terminal device is the user capable of executing the function provided by the discovered communication device, based on the user information stored in the storage, and permit or reject providing the device function information based on the determination result, when the inquiry is made.

4. The communication system of claim 1, wherein
the device function information includes information used to execute the function provided by the communication device or an application programming interface (API).

5. The communication system of claim 1, wherein
the first processor is further configured to:
receive first unique information that is unique to the communication device and second unique information that is unique to the controller when the controller is connected to the communication device; and
determine whether the communication device is connectible to the controller, based on the received first and second unique information,
the first unique information includes the device function information, and
the first processor is further configured to provide the terminal device with the device function information included in the first unique information when it is determined that the communication device is connectible to the controller.

6. The communication system of claim 5, wherein
the controller is configured to:
receive connection availability information including the determination result from the server device via the communication device; and
reject the connection of the communication device, based on the received connection availability information.

7. The communication system of claim 6, wherein
the controller is further configured to:
supply power to the communication device; and
stop supplying power to the communication device when the connection of the communication device is rejected.

8. The communication system of claim 7, wherein
the first processor is further configured to notify the communication device of information to be set in the communication device when it is determined that the communication device is connectible to the controller.

9. The communication system of claim 8, wherein
the communication device is configured to make advertisement to the terminal device, based on the notified information, when the terminal device discovers the communication device.

10. The communication system of claim 9, wherein
the first processor is further configured to provide the terminal device with the device function information in response to the inquiry from the terminal device, which is made based on the advertisement.

11. The communication system of claim 1, wherein
the communication device is configured to be connected to the controller via a connection interface provided in the edge device.

12. A server device connected to a terminal device via a network, the server device comprising a processor configured to:
accept an inquiry to a function provided by a communication device when the terminal device discovers the communication device connected to a controller provided in an edge device; and
provide the terminal device with device function information on the function provided by the communication device in response to the accepted inquiry, wherein
the terminal device is configured to request the communication device to execute a function provided by the communication device, based on the provided device function information.

13. A server device connected to a terminal device via a network, the server device comprising a processor configured to:
make an inquiry to a function provided by a communication device when discovering the communication device connected to a controller provided in an edge device;
receive device function information on a function provided by the communication device provided by the server device in response to the inquiry; and
request the communication device to execute a function provided by the communication device, based on the received device function information.

14. A method executed by a communication system comprising a server device and a terminal device connected to the server device via a network, the method comprising:
providing the terminal device with device function information on a function provided by a communication device from the server device when the terminal device discovers the communication device connected to a controller provided in an edge device; and
requesting the communication device to execute a function provided by the communication device from the terminal device, based on the provided device function information.

15. A method executed by a server device connected to a terminal device via a network, the method comprising:
accepting an inquiry to a function provided by a communication device when the terminal device discovers the communication device connected to a controller provided in an edge device; and
providing the terminal device with device function information on the function provided by the communication device in response to the accepted inquiry, wherein
the terminal device is configured to request the communication device to execute a function provided by the communication device, based on the provided device function information.
